(19) United States
(12) Patent Application Publication
(10) Pub. No.: US 2017/0165911 A1
(43) Pub. Date: Jun. 15, 2017

(54) THREE DIMENSIONAL MODELING APPARATUS

(71) Applicant: NABTESCO CORPORATION, Tokyo (JP)

(72) Inventors: Tomohiro KIRIYAMA, Kobe-shi (JP); Mitsuhisa KITAMURA, Tokyo (JP); Hiroshi YOKOYAMA, Tokyo (JP); Koichi NOGUCHI, Tokyo (JP)

(21) Appl. No.: 15/377,466

(22) Filed: Dec. 13, 2016

(30) Foreign Application Priority Data
Dec. 15, 2015 (JP) 2015-244580
Dec. 15, 2015 (JP) 2015-244584

(51) Int. Cl. B29C 67/00; B33Y 50/02; B33Y 30/00

(52) U.S. Cl. CPC B29C 67/0077; B33Y 30/00; B33Y 50/02

(57) ABSTRACT

A three-dimensional modeling apparatus models a three-dimensional object by lamination modeling in an air-tight process chamber. The three-dimensional modeling apparatus includes an elevation guide chamber provided adjacent to the process chamber, an elevation stage provided so as to be capable of being raised and lowered in the elevation guide chamber, and a communication pipe communicating between a space below the elevation stage in the elevation guide chamber and the process chamber.

### CROSS-REFERENCE TO RELATED APPLICATIONS

This application is based on and claims the benefit of priority from Japanese Patent Application Serial No. 2015-244580 filed on Dec. 15, 2015 and Japanese Patent Application Serial No. 2015-244584 filed on Dec. 15, 2015, the contents of which are hereby incorporated by reference in their entirety.

### TECHNICAL FIELD

The present invention relates to a three-dimensional modeling apparatus, and in particular to a three-dimensional modeling apparatus for modeling a three-dimensional object using an elevation stage capable of elevation.

### BACKGROUND

A three-dimensional modeling apparatus, which is also called a 3D printer, enables easy and quick modeling of parts having relatively complex structure, and more attention is being paid thereto. There have been proposed various methods of modeling with a three-dimensional modeling apparatus. For example, AM (Additive Manufacturing) technology has been employed in a wide range of three-dimensional modeling apparatuses.

One example of AM technology is the lamination modeling method, in which an elevation stage is lowered gradually while layers of a material are stacked thereon, thereby to produce a desired three-dimensional object. This method typically includes steps of applying a laser beam onto a powder material on the elevation stage for sintering, lowering the elevation stage, placing additional powder material on the lowered elevation stage, and applying a laser beam onto the additional powder material for sintering. These steps are repeated to gradually form layers of a three-dimensional object.

For example, Patent Literature 1 discloses an apparatus for producing a three-dimensional object by solidifying a powdery modeling material into layers. In this apparatus, a powder layer is placed on a modeling platform that can move vertically, and a laser beam is applied onto the powder layer for solidification of the powder. Then, the modeling platform is lowered, a new powder layer is placed on the modeling platform, and a laser beam is applied onto the new powder layer. Such a series of steps are repeated to produce a three-dimensional object.

In addition, Patent Literature 2 discloses a method of producing a metal article by lamination modeling with an electron beam, instead of a laser beam. In general, oxidation of a metal material during sintering causes brittleness of the produced object. In the method disclosed in Patent Literature 2, sintering proceeds in an atmosphere of an inert gas such as argon, nitrogen, etc., such that the oxidation of the metal during sintering can be prevented.

### RELEVANT REFERENCES

### List of Relevant Patent Literature

Patent Literature 1: Japanese Patent Application Publication No. 2013-526429

Patent Literature 2: Japanese Patent Application Publication No. 2015-525290

### SUMMARY

### Problems to be Solved by the Invention

As stated above, oxidation of a material during modeling is unfavorable for ensuring a desired strength of the three-dimensional object produced. Therefore, sintering of a material should preferably proceed in an environment filled with an inert gas and containing no oxygen (O₂).

Since it cannot be visually determined whether oxygen is present in a modeling apparatus, the presence of oxygen need to be determined based on a sensing value of an oxygen sensor provided in the modeling apparatus. However, oxygen included in a locally accumulated air cannot be detected by an oxygen sensor. Therefore, oxygen included in the air accumulated in a position separated from the oxygen sensor (e.g., a position below the elevation stage) cannot be detected when the elevation stage is stopped, whereas when the elevation stage is being raised or lowered, oxygen may be diffused to cause oxidation of the material being sintered. In a large apparatus in particular, an elevation stage having a large area displaces a large volume of air, causing a large amount of oxygen to diffuse within a chamber swiftly.

Between the elevation guide chamber and the elevation stage raised and lowered in the elevation guide chamber, there is provided a sealing member for preventing the powder material placed on the elevation stage from falling down. Such a sealing member works favorably for preventing the powder material from falling down but does not completely block a gas such as oxygen. Even when the sealing member provides relatively high tightness, a gap may be produced between the elevation stage or the elevation guide chamber and the sealing member while the elevation stage is repeatedly raised and lowered, and the gap may cause leakage of oxygen.

To ensure that the material used for producing a three-dimensional object is not oxidized, an oxygen sensor may be installed in the modeling apparatus and, when the oxygen sensor senses an oxygen density equal to or greater than a predetermined threshold value during modeling, the modeling operation may be stopped automatically. In this case, the oxygen sensor may sense an oxygen density equal to or greater than a predetermined threshold value and stop the modeling operation at timings not intended by an operator. To handle such interruption of the modeling operation quickly, the operator needs to pay attention to the modeling apparatus constantly during the modeling operation, resulting in a very large load imparted to the operator.

As described above, the material may be oxidized when the elevation stage is raised or lowered and the accumulated oxygen is diffused. It is a possible option to circulate a large amount of inert gas within the modeling apparatus so as to discharge the inert gas more quickly than the oxygen diffuses. However, this method requires a large amount of inert gas and is wasteful.

Therefore, it is essential to prevent accumulation of oxygen in the modeling apparatus. There has been a demand for an apparatus that discharges oxygen efficiently.

The Inventors have found that a large amount of oxygen accumulates particularly in a space enclosed by the elevation stage and the elevation guide chamber (typically, a space below the elevation stage).

The present invention is intended to overcome the above problems, and one object thereof is to provide a three-dimensional modeling apparatus that can prevent oxidation of a material during modeling of a three-dimensional object.

### Means for Solving the Problem

One aspect of the present invention relates to a three-dimensional modeling apparatus for modeling a three-dimensional object by lamination modeling in an air-tight process chamber, the three-dimensional modeling apparatus comprising: an elevation guide chamber provided adjacent to the process chamber; an elevation stage provided so as to be capable of being raised and lowered in the elevation guide chamber; and at least one communication pipe communicating between a space below the elevation stage in the elevation guide chamber and the process chamber.

The at least one communication pipe may communicate between a space below a movement range of the elevation stage in the elevation guide chamber and the process chamber.

The elevation stage may serve for modeling conducted thereon.

The at least one communication pipe may include a plurality of communication pipes,

The plurality of communication pipes may communicate with the process chamber via the same wall portion among a plurality of wall portions constituting the process chamber and communicate with the elevation guide chamber via the same wall portion among a plurality of wall portions constituting the elevation guide chamber.

The at least one communication pipe may include a curved channel.

The at least one communication pipe may communicate with the process chamber at a position closer to an oxygen sensor than to a gas supply unit, the oxygen sensor being configured to sense an oxygen density in the process chamber, the gas supply unit being configured to supply an inert gas to the process chamber.

The three-dimensional modeling apparatus may further include a drive chamber containing at least a part of an elevation drive unit configured to raise and lower the elevation stage, wherein the drive chamber may communicate with the elevation guide chamber via a communication aperture, and the at least one communication pipe may communicate between the drive chamber and the process chamber.

The three-dimensional modeling apparatus may further include a drive chamber containing at least a part of an elevation drive unit configured to raise and lower the elevation stage, wherein the at least one communication pipe may further communicate between the process chamber and the drive chamber

The at least one communication pipe may include a process chamber communication channel that communicates with the process chamber, elevation guide chamber communication channels that branch from the process chamber communication channel and communicate with the elevation guide chambers, and a drive chamber communication channel that branches from the process chamber communication channel and communicates with the drive chamber. The cross-sectional area of the drive chamber communication channel may be larger than that of the elevation guide chamber communication channel.

The at least one communication pipe may include a process chamber communication channel that communicates with the process chamber, elevation guide chamber communication channels that branch from the process chamber communication channel and communicate with the elevation guide chambers, and a drive chamber communication channel that branches from the process chamber communication channel and communicates with the drive chamber. The cross-sectional area of the drive chamber communication channel may be smaller than that of the process chamber communication channel.

The three-dimensional modeling apparatus may further include a drive chamber containing an elevation drive unit configured to raise and lower the elevation stage, and at least one communication aperture in a wall between the elevation guide chamber and the drive chamber, the at least one communication aperture communicating between the elevation guide chamber and the drive chamber.

The three-dimensional modeling apparatus may comprise a plurality of elevation units each including the elevation guide chamber and the elevation stage, and the at least one communication pipe may comprise a plurality of communication pipes that communicate between each of the elevation guide chambers of the plurality of elevation units and the process chamber.

The plurality of communication pipes may include a first communication pipe and a second communication pipe, and the first communication pipe may communicate with the elevation guide chamber at a position above the position where the second communication pipe communicates with the elevation guide chamber.

The first communication pipe may communicate with the process chamber at a position closer to an oxygen sensor than to a gas supply unit, the oxygen sensor being configured to sense an oxygen density in the process chamber, the gas supply unit being configured to supply an inert gas to the process chamber.

The cross-sectional area of the channel of the first communication pipe may be larger than that of the channel of the second communication pipe.

At least one of the first communication pipe and the second communication pipe may be provided with a channel adjusting unit that can adjust the cross-sectional area of the channel.

The three-dimensional modeling apparatus may comprise a plurality of elevation units each including the elevation guide chamber and the elevation stage, and the plurality of communication pipes communicate between at least one of the elevation guide chambers of the plurality of elevation units and the process chamber. The elevation guide chambers of the plurality of elevation units are arranged adjacent to each other, and any two elevation guide chambers arranged adjacent to each other communicate with each other via a communication hole.

The three-dimensional modeling apparatus comprises three or more elevation units arranged adjacent to each other, and any two of the three or more elevation guide chambers arranged adjacent to each other communicate with each other via a communication hole. The opening cross-sectional area of the communication hole that communicates between the elevation guide chamber to which the communication pipe may be connected and the elevation guide chamber to which the communication pipe may not be connected may be larger than the opening cross-sectional area of the communication hole that communicates between the elevation guide chambers to which the communication pipe may not be connected.

The three-dimensional modeling apparatus may further include a drive chamber containing at least a part of an elevation drive unit configured to raise and lower the elevation stage, and at least one communication aperture communicating between at least one of the plurality of elevation guide chambers and the drive chamber.

The three-dimensional modeling apparatus may comprise a plurality of elevation units each including the elevation guide chamber and the elevation stage, the at least one communication pipe may comprise a plurality of communication pipes, the plurality of communication pipes include a first communication pipe and a second communication pipe, the first communication pipe may communicate with the elevation guide chamber at a position above the position where the second communication pipe communicates with the elevation guide chamber, the plurality of communication pipes may communicate between at least one of the elevation guide chambers of the plurality of elevation units and the process chamber, and the plurality of elevation guide chambers may be arranged adjacent to each other, and any two elevation guide chambers arranged adjacent to each other may communicate with each other via a communication hole.

The first communication pipe may communicate with the process chamber at a position closer to an oxygen sensor than to a gas supply unit, the oxygen sensor being configured to sense an oxygen density in the process chamber, the gas supply unit being configured to supply an inert gas to the process chamber.

The cross-sectional area of the channel of the first communication pipe may be larger than that of the channel of the second communication pipe.

At least one of the first communication pipe and the second communication pipe may be provided with a channel adjusting unit that can adjust the cross-sectional area of the channel.

The plurality of elevation guide chambers may include a first elevation guide chamber, a second elevation guide chamber, and a third elevation guide chamber arranged between the first elevation guide chamber and the second elevation guide chamber. The first elevation guide chamber and the third elevation guide chamber may communicate with each other via a communication hole. The second elevation guide chamber and the third elevation guide chamber may communicate with each other via a communication hole. At least one of the first communication pipe and the second communication pipe may communicate between the first elevation guide chamber and the process chamber. The cross-sectional area of the communication hole that communicates between the second elevation guide chamber and the third elevation guide chamber may be larger than that of the communication hole that communicates between the first elevation guide chamber and the third elevation guide chamber.

The first communication pipe may communicate between the first elevation guide chamber and the process chamber.

The second communication pipe may communicate between the second elevation guide chamber and the process chamber.

In the three-dimensional modeling apparatus, the at least one communication pipe may include a plurality of branch pipes, the plurality of branch pipes being respectively connected to a plurality of connection openings provided in a wall portion of the elevation guide chamber at a plurality of different positions with respect to a vertical direction, each of the plurality of branch pipes is provided with a valve configured to open and close a channel, the three-dimensional modeling apparatus further comprises: an opening/closing control unit configured to open and close the valves in accordance with an elevation level of the elevation stage, and the opening/closing control unit controls the valves so as to close the channels of the branch pipes connected to the connection openings provided in a space above the elevation stage in the elevation guide chamber.

The opening/closing controller may control the channel adjusting units provided on the plurality of branch pipes such that when two or more branch pipes are opened to the space below the elevation stage in the elevation guide chamber, the channels of a predetermined number of branch pipes positioned relatively above among the two or more branch pipes may be opened, and the channels of the other branch pipes among the two or more branch pipes may be closed.

The three-dimensional modeling apparatus may include an elastic member provided below the elevation stage in the elevation guide chamber. The elastic member may be contracted and expanded in accordance with the elevation level of the elevation stage. The elastic member may include a hollow portion formed therein, a first open communication portion that communicates between the hollow portion and the elevation guide chamber, and a second open communication portion that communicates between the hollow portion and the communication pipe.

The three-dimensional modeling apparatus may further include an elastic member provided below the elevation stage in the elevation guide chamber. The elastic member may be attached to the elevation stage. The elastic member may be contracted and expanded in accordance with the elevation level of the elevation stage. The elastic member may include a hollow portion formed therein, a first open communication portion that communicates between the hollow portion and the elevation guide chamber, and a second open communication portion that communicates between the hollow portion and the communication aperture.

The three-dimensional modeling apparatus may further include a first gas supply unit configured to supply an inert gas to the process chamber, and a second gas supply unit configured to supply the inert gas to the elevation guide chamber.

The second gas supply unit may supply an inert gas to the elevation guide chamber provided in one end of the plurality of elevation guide chambers arranged adjacent to each other, and the communication pipe may communicate between the elevation guide chamber provided in the other end of the plurality of elevation guide chambers arranged adjacent to each other and the process chamber.

The communication pipe may be provided to the elevation guide chamber positioned off the line extending from the second gas supply unit in the direction of the blow of the inert gas from the second gas supply unit.

The second gas supply unit may be provided on the wall portion that forms the elevation guide chamber provided in one end. The communication pipe may be provided on the wall portion that forms the elevation guide chamber provided in the other end. The wall portion on which the second gas supply unit is formed and the wall portion on which the communication pipe is formed may not be in parallel with each other.

Any two elevation guide chambers arranged adjacent to each other may communicate with each other via a communication hole. The communication hole may be positioned off the line connecting the second gas supply unit with an opening of the communication pipe opened to the elevation guide chamber.

The cross-sectional area of the opening of the communication pipe opened to the elevation guide chamber may be larger than that of the gas supply aperture of the second gas supply unit.

Another aspect of the present invention relates to a three-dimensional modeling apparatus for modeling a three-dimensional object by lamination modeling in an air-tight process chamber, the three-dimensional modeling apparatus comprising: an elevation guide chamber provided adjacent to the process chamber; an elevation stage provided so as to be capable of being raised and lowered in the elevation guide chamber; an inert gas supply opening for supplying an inert gas to a space below the elevation stage in the elevation guide chamber, and a gas discharge opening for discharging gases in the space below the elevation stage in the elevation guide chamber.

The inert gas supply opening and the gas discharge opening may be opened to a space below a movement range of the elevation stage in the elevation guide chamber.

The elevation stage may serve for modeling conducted thereon.

The inert gas supply opening and the gas discharge opening may be positioned at different levels with respect to the vertical direction.

The three-dimensional modeling apparatus may comprise a plurality of elevation units each including the elevation guide chamber and the elevation stage, the inert gas supply opening and the gas discharge opening may be opened to at least one of the elevation guide chambers of the plurality of elevation units, and the plurality of elevation guide chambers may be arranged adjacent to each other, and any two elevation guide chambers arranged adjacent to each other may communicate with each other via a communication hole.

The inert gas supply opening may be opened to the elevation guide chamber provided in one end of the plurality of elevation guide chambers arranged adjacent to each other, and the gas discharge opening may be opened to the elevation guide chamber provided in the other end of the plurality of elevation guide chambers arranged adjacent to each other.

The inert gas supply opening may be opened to the space below the movement range of the elevation stage in the elevation guide chamber provided in one end, and the gas discharge opening may be opened to the space below the movement range of the elevation stage in the elevation guide chamber provided in the other end.

The inert gas supply opening may be provided in the wall portion that forms the elevation guide chamber provided in one end. The gas discharge opening may be provided in the wall portion that forms the elevation guide chamber provided in the other end. The wall portion in which the inert gas supply opening is formed and the wall portion in which the gas discharge opening is formed may not be in parallel with each other.

The three-dimensional modeling apparatus may further include a drive chamber containing an elevation drive unit configured to raise and lower the elevation stage, wherein the drive chamber may communicate with the elevation guide chamber via a communication aperture, and the inert gas supply opening may be opened to the elevation guide chamber, and the gas discharge opening may be opened to the drive chamber.

The three-dimensional modeling apparatus may comprise a plurality of elevation units each including the elevation guide chamber and the elevation stage, the elevation guide chambers of the plurality of elevation units may be arranged adjacent to each other, and any two elevation guide chambers arranged adjacent to each other may communicate with each other via a communication hole. The drive chamber may communicate with at least one of the plurality of elevation guide chambers via a communication hole, and the inert gas supply opening may be opened to at least one of the plurality of elevation guide chambers.

The wall portion of the elevation guide chamber in which the inert gas supply opening is formed and the wall portion of the drive chamber in which the gas discharge opening is formed may be in parallel with each other.

The plurality of elevation guide chambers may include a first elevation guide chamber, a second elevation guide chamber, and a third elevation guide chamber arranged between the first elevation guide chamber and the second elevation guide chamber. The first elevation guide chamber and the third elevation guide chamber may communicate with each other via a communication hole. The second elevation guide chamber and the third elevation guide chamber may communicate with each other via a communication hole. The inert gas supply opening may be opened to the second elevation guide chamber. The cross-sectional area of the communication hole that communicates between the first elevation guide chamber and the third elevation guide chamber may be larger than that of the communication hole that communicates between the second elevation guide chamber and the third elevation guide chamber.

The three-dimensional modeling apparatus may further comprise a drive chamber containing an elevation drive unit configured to raise and lower the elevation stage, wherein the inert gas supply opening may be opened to the drive chamber, the gas discharge opening may be opened to the elevation guide chamber, and the drive chamber and the elevation guide chamber may communicate with each other.

The inert gas supply opening may be provided to the elevation guide chamber positioned off the line extending from the gas discharge opening in the direction of opening of the gas discharge opening.

The communication holes may include a communication hole positioned off the line connecting the inert gas supply opening with the gas discharge opening.

The gas discharge opening may be connected to a gas collection unit configured to collect the gases, the gas collection unit serving as a recycling unit configured to recycle the inert gas.

According to an aspect of the present invention, the gas channel having at least a part thereof formed of the communication pipe may communicate between the process chamber on which a gas discharge unit is provided and the space below the elevation stage in the elevation guide chamber. Thus, it may be possible to guide the oxygen gas accumulating in the three-dimensional modeling apparatus (particularly in the space below the elevation stage) to the process chamber via the communication pipe and discharge the oxygen gas out of the three-dimensional modeling apparatus via the gas discharge unit, effectively preventing oxidation of the material of the three-dimensional object during modeling.

According to another aspect of the present invention, the inert gas may be supplied to the space below the elevation stage in the elevation guide chamber via the inert gas supply opening, and the gas containing oxygen may be discharged from the space via the gas discharge opening. Thus, it may be possible to discharge the oxygen gas accumulating in the three-dimensional modeling apparatus (particularly in the elevation guide chamber) out of the three-dimensional modeling apparatus, effectively preventing oxidation of the material of the three-dimensional object during modeling.

### BRIEF DESCRIPTION OF THE DRAWINGS

FIG. 1 shows a three-dimensional modeling apparatus according to a first mode of a first embodiment.

FIG. 2A shows the three-dimensional modeling apparatus of FIG. 1 as viewed from a side thereof (see the arrow S in FIG. 1), including an example of a communication pipe.

FIG. 2B shows the three-dimensional modeling apparatus of FIG. 1 as viewed from a side thereof (see the arrow S in FIG. 1), including another example of the communication pipe.

FIG. 3 shows a three-dimensional modeling apparatus according to a second mode of the first embodiment.

FIG. 4 shows the three-dimensional modeling apparatus of FIG. 3 as viewed from a side thereof (see the arrow S in FIG. 3).

FIG. 5 shows a three-dimensional modeling apparatus according to a third mode of the first embodiment.

FIG. 6 shows the three-dimensional modeling apparatus of FIG. 5 as viewed from a side thereof (see the arrow S in FIG. 5).

FIG. 7 shows a three-dimensional modeling apparatus according to a fourth mode of the first embodiment.

FIG. 8 shows the three-dimensional modeling apparatus of FIG. 7 as viewed from a side thereof (see the arrow S in FIG. 7).

FIG. 9 shows a three-dimensional modeling apparatus according to a fifth mode of the first embodiment.

FIG. 10 shows the three-dimensional modeling apparatus of FIG. 9 as viewed from a side thereof (see the arrow S in FIG. 9).

FIG. 11 shows a three-dimensional modeling apparatus according to a sixth mode of the first embodiment.

FIG. 12 shows the three-dimensional modeling apparatus of FIG. 11 as viewed from a side thereof (see the arrow S in FIG. 11).

FIG. 13 shows a three-dimensional modeling apparatus according to a seventh mode of the first embodiment.

FIG. 14 shows the three-dimensional modeling apparatus of FIG. 13 as viewed from a side thereof (see the arrow S in FIG. 13).

FIG. 15 shows a three-dimensional modeling apparatus according to an eighth mode of the first embodiment.

FIG. 16 shows a three-dimensional modeling apparatus according to a ninth mode of the first embodiment.

FIG. 17 shows a three-dimensional modeling apparatus according to a tenth mode of the first embodiment.

FIG. 18 shows a three-dimensional modeling apparatus according to an eleventh mode of the first embodiment.

FIG. 19 shows a variation of the three-dimensional modeling apparatus of FIG. 18.

FIG. 20 shows a three-dimensional modeling apparatus according to a twelfth mode of the first embodiment.

FIG. 21 shows the three-dimensional modeling apparatus of FIG. 20 as viewed from a side thereof (see the arrow S in FIG. 20).

FIG. 22 is a block diagram showing an example of functionality of a controller according to the twelfth mode of the first embodiment.

FIG. 23 is a flowchart showing an example of operation of opening/closing a channel adjusting unit performed by the controller according to the twelfth mode of the first embodiment.

FIG. 24 shows a three-dimensional modeling apparatus according to a thirteenth mode of the first embodiment.

FIG. 25 shows the three-dimensional modeling apparatus of FIG. 24 as viewed from a side thereof (see the arrow S in FIG. 24).

FIG. 26 shows a three-dimensional modeling apparatus according to a fourteenth mode of the first embodiment.

FIG. 27 shows the three-dimensional modeling apparatus of FIG. 26 as viewed from a side thereof (see the arrow S in FIG. 26).

FIG. 28 shows a three-dimensional modeling apparatus according to a fifteenth mode of the first embodiment.

FIG. 29 shows the three-dimensional modeling apparatus of FIG. 28 as viewed from a side thereof (see the arrow S in FIG. 28).

FIG. 30 shows a three-dimensional modeling apparatus according to a sixteenth mode of the first embodiment.

FIG. 31 shows the three-dimensional modeling apparatus of FIG. 30 as viewed from a side thereof (see the arrow S in FIG. 30).

FIG. 32 shows a three-dimensional modeling apparatus according to a seventeenth mode of the first embodiment.

FIG. 33 shows a three-dimensional modeling apparatus according to a first mode of a second embodiment.

FIG. 34 schematically shows the three-dimensional modeling apparatus of FIG. 33 as viewed from a side thereof (see the arrow S in FIG. 33).

FIG. 35 shows a three-dimensional modeling apparatus according to a second mode of the second embodiment.

FIG. 36 shows a three-dimensional modeling apparatus according to a third mode of the second embodiment.

FIG. 37 shows a three-dimensional modeling apparatus according to a fourth mode of the second embodiment.

FIG. 38 shows a three-dimensional modeling apparatus according to a fifth mode of the second embodiment.

FIG. 39 shows a three-dimensional modeling apparatus according to a sixth mode of the second embodiment.

FIG. 40 shows the three-dimensional modeling apparatus of FIG. 39 as viewed from a side thereof (see the arrow S in FIG. 39).

FIG. 41 shows a three-dimensional modeling apparatus according to a seventh mode of the second embodiment.

### DESCRIPTION OF EXAMPLE EMBODIMENTS

Embodiments of the present invention will now be described with reference to the attached drawings. In the attached drawings, some dimensions and aspect ratios are conveniently altered from actual values for emphasis. The terms and values used herein to specify a shape, a geometric condition, and an extent thereof are not bound to a strict meaning thereof but should be interpreted as covering a range achieving the same functionality. In addition, the terms “above” and “below” used herein are based on the vertical direction according to the direction of gravity.

### First Embodiment

### <First Mode>

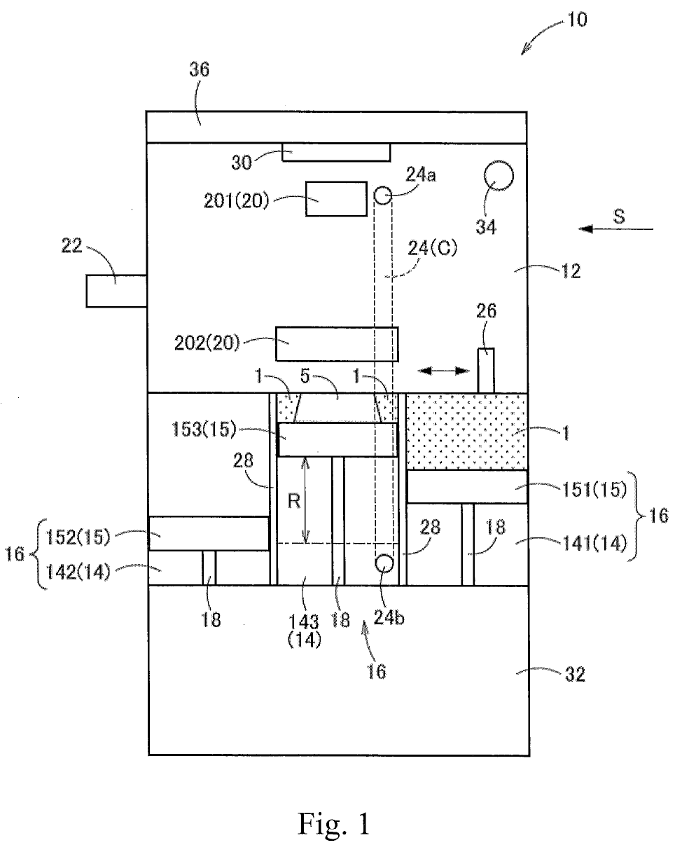

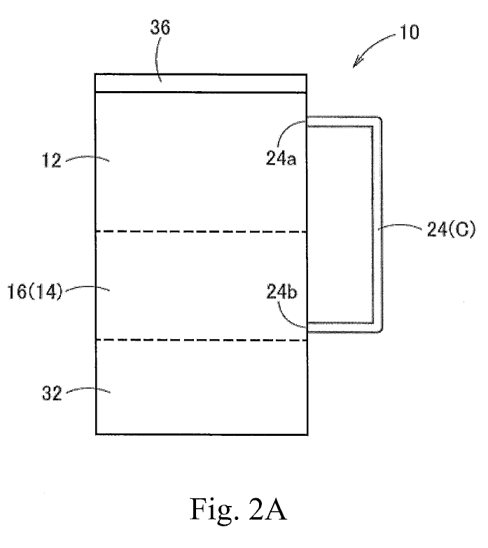

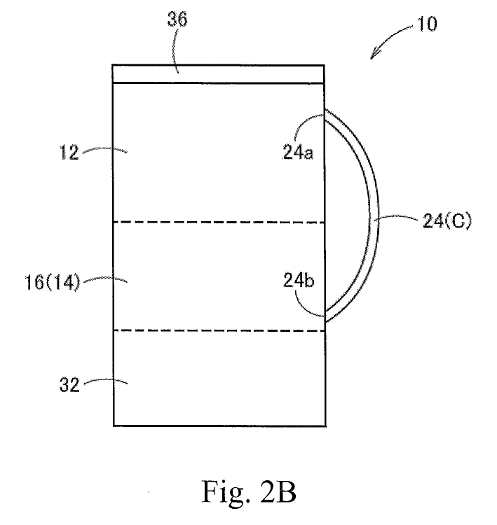

FIG. 1 shows a three-dimensional modeling apparatus 10 according to a first mode. FIGS. 2A and 2B show the three-dimensional modeling apparatus 10 of FIG. 1 as viewed from a side thereof (see the arrow S in FIG. 1). FIG. 2A includes an example of a communication pipe 24, and FIG. 2B includes another example of the communication pipe 24. In FIG. 1, a process chamber 12 and elevation units 16 are schematically illustrated with the interior thereof as viewed from a side, so as to facilitate comprehension. Further, in FIG. 1, the communication pipe 24 shown with a dotted line may be provided outside the process chamber 12 and the elevation units 16 (see FIG. 2A and FIG. 2B).

The three-dimensional modeling apparatus 10 according to this mode may conduct lamination modeling of a three-dimensional object 5 by sintering (solidifying) a powder material 1 such as titanium in the air-tight process chamber 12, and may include the process chamber 12, a plurality of elevation units 16 (three elevation units 16 in this mode) provided below the process chamber 12, and a drive chamber 32 provided below the elevation units 16. The powder material 1 may be a metal powder made of titanium, iron, stainless steel, aluminum, steel, or other alloys, a synthetic powder such as polyamide or polystyrene, polyether ether ketone (PEEK), synthetic coating sand, or a ceramic powder.

Each of the elevation units 16 may include an elevation guide chamber 14 provided adjacent to the process chamber 12 and an elevation stage 15 provided so as to be capable of being raised and lowered in the elevation guide chamber 14. Each elevation stage 15 may be raised and lowered so as to slide on the surfaces of side walls that define the associated elevation guide chamber 14. In each elevation guide chamber 14, there may be provided a sealing member (not shown) between the surfaces of the side walls of the elevation guide chamber 14 and the associated elevation stage 15, and the sealing member may block a gap therebetween. The sealing member may block the powder material 1 such that the powder material 1 may not pass the gap between the elevation guide chamber 14 and the elevation stage 15. The sealing member may preferably prevent a gas such as oxygen from passing the gap between the elevation guide chamber 14 and the elevation stage 15 but may not necessarily provide strict air-tightness. Thus, each of the elevations guide chambers 14 may be partitioned by the associated elevation stage 15 into a space above the elevation stage 15 and a space below the elevation stage 15.

The three elevation units 16 may be constituted by a dispenser unit, a collection unit, and a building unit provided between the dispenser unit and the collection unit. The dispenser unit may include a dispenser elevation guide chamber 141 (a first elevation guide chamber) and a dispenser elevation stage 151, the building unit may include a building elevation guide chamber 143 (a third elevation guide chamber) and a building elevation stage 153, and the collection unit may include a collection elevation guide chamber 142 (a second elevation guide chamber) and a collection elevation stage 152. FIG. 1 shows the dispenser unit, the building unit, and the collection unit arranged in this order from right to left. There may be provided partition walls 28 between the dispenser elevation guide chamber 141 and the building elevation guide chamber 143 and between the collection elevation guide chamber 142 and the building elevation guide chamber 143. The dispenser elevation guide chamber 141, the building elevation guide chamber 143, and the collection elevation guide chamber 142 may be arranged adjacent to each other with the partition walls 28 therebetween.

Each of the elevation stages 15 (the dispenser elevation stage 151, the collection elevation stage 152, and the building elevation stage 153) may be provided with an elevation drive unit 18 configured to raise and lower the elevation stages 15. The elevation drive unit 18 may raise and lower the associated elevation stage 15 under the control by a controller 36. The dispenser elevation stage 151, the collection elevation stage 152, and the building elevation stage 153 may be raised and lowered in association with each other.

The dispenser unit (the dispenser elevation guide chamber 141 and the dispenser elevation stage 151) may provide a space for retaining the powder material 1, and the powder material 1 used for modeling the three-dimensional object 5 may be placed on the dispenser elevation stage 151. The building unit (the building elevation guide chamber 143 and the building elevation stage 153) may conduct modeling of the three-dimensional object 5, in which the powder material 1 placed on the building elevation stage 153 may be sintered with a laser beam emitted from an emission unit 30 to form the three-dimensional object 5. The collection unit (the collection elevation guide chamber 142 and the collection elevation stage 152) may provide a space for collecting an excess portion of the powder material 1 supplied to the building elevation guide chamber 143, and the excess portion of the powder material 1 may be accumulated on the collection elevation stage 152.

The process chamber 12 may contain an application unit 26 that can reciprocate horizontally above the dispenser elevation stage 151, the building elevation stage 153, and the collection elevation stage 152. When the application unit 26 moves horizontally, the powder material 1 may be supplied from the dispenser elevation guide chamber 141 into the building elevation guide chamber 143, and the excess portion of the powder material 1 may be pressed from above the building elevation guide chamber 143 into the collection elevation guide chamber 142. More specifically, the first step to supply a required amount of powder material 1 into the building elevation guide chamber 143 may be to raise the dispenser elevation stage 151, lower the building elevation stage 153, and lower the collection elevation stage 152. Then, the application unit 26 disposed above the dispenser elevation stage 151 may move horizontally to above the building elevation guide chamber 143 and the collection elevation guide chamber 142. Thus, the topmost portion of the powder material 1 on the dispenser elevation stage 151 may be pressed toward the building elevation guide chamber 143, and further powder material 1 may be supplied into the building elevation guide 143. The excess portion of the powder material 1 that is not contained in the building elevation guide chamber 143 may be pressed toward the collection elevation guide chamber 142 and collected.

Thus, the operation of the application unit 26 and the elevation stages 15 (the dispenser elevation stage 151, the collection elevation stage 152, and the building elevation stage 153) may be performed in cooperation with each other under the control by the controller 36, such that an adequate amount of powder material 1 can be supplied into the building elevation stage 153 to form layers. The distances by which the dispenser elevation stage 151 is raised, the building elevation stage 153 is lowered, and the collection elevation stage 152 is lowered may preferably be set such that a slightly larger amount of powder material 1 than is required to be supplied to above the building elevation stage 153 is supplied from the dispenser elevation guide chamber 141 to above the building elevation stage 153 and the excess portion of the powder material 1 that is not contained in the building elevation guide chamber 143 is contained in the collection elevation guide chamber 142. In addition, the distance by which the building elevation stage 153 is lowered may be set in accordance with the thickness of the layer of the powder material 1 to be sintered by application of a laser beam. By way of an example, it may be possible to lower the collection elevation stage 152 and the building elevation stage 153 by 0.1 mm and raise the dispenser elevation stage 151 by 0.2 mm for one stroke.

The process chamber 12 may also contain a gas supply unit 20, a gas discharge unit 22, an emission unit 30, and an oxygen sensor 34, in addition to the application unit 26.

The gas supply unit 20 in this mode may include a first gas supply unit 201, 202 for supplying an inert gas such as argon or nitrogen (particularly argon in this mode) to the process chamber 12. In the example shown in FIG. 1, the first gas supply unit 201, 202 may include a first blow unit 201 provided above the building unit (the building elevation guide chamber 143 and the building elevation stage 153) and a second blow unit 202 provided between the building unit and the first blow unit 201 (that is, below the first blow unit 201). The first blow unit 201 and the second blow unit 202 may blow an inert gas into the space above the building unit so as not to substantially impact the powder material 1 placed on the building elevation stage 153 and the three-dimensional object 5. The specific configuration and the position of the gas supply unit 20 are not particularly limited but may be set such that an inert gas can be supplied to at least one of the process chamber 12 and the elevation guide chambers 14.

The gas discharge unit 22 may communicate with the process chamber 12 and may be configured to discharge gases from the process chamber 12 out of the three-dimensional modeling apparatus 10.

The emission unit 30 according to this mode may emit a laser beam onto the powder material 1 on an elevation stage 15 (the building elevation stage 153 in this example) to solidify the powder material 1 (sinter the powder material 1 in this example). In the example shown in FIG. 1, the emission unit 30 may be installed in the process chamber 12 above the building unit (the building elevation guide chamber 143 and the building elevation stage 153). However, the position to install the emission unit 30 may not be particularly limited. The emission unit 30 may be installed in other positions within the process chamber 12 or installed outside the process chamber 12, as long as it can appropriately emit a laser beam onto the powder material 1 on the building elevation stage 153.

The oxygen sensor 34 may be installed in the process chamber 12 and may be configured to sense the oxygen density. The position to install the oxygen sensor 34, which may not be particularly limited, may preferably be set based on the relationship between the specific weights of the inert gas supplied from the gas supply unit 20 and oxygen. For example, if the specific weight of oxygen is smaller than that of the inert gas, the oxygen sensor 34 may preferably be installed in a relatively high position within the process chamber 12, and if the specific weight of oxygen is larger than that of the inert gas, the oxygen sensor 34 may preferably be installed in a relatively low position within the process chamber 12. The position to install the oxygen sensor 34 may preferably be set such that the communication pipe 24 (described later) may be opened to (communicate with) the process chamber 12 at a position closer to the oxygen sensor 34 than to the position where the gas supply unit 20 (the first blow unit 201 and the second blow unit 202 in this example) supplies an inert gas in the process chamber 12.

The communication pipe 24 may form at least a part of a gas channel C communicating between the process chamber 12 and the spaces in the elevation guide chambers 14 below the elevation stages 15. The communication pipe 24 in this mode may connect to the process chamber 12 and the elevation guide chambers 14 (particularly the building elevation guide chamber 143), communicate with the process chamber 12 via a process chamber opening 24a, and communicate with the building elevation guide chamber 143 via an elevation chamber opening 24b.

The shape of the gas channel C formed by the communication pipe 24 may not be particularly limited. For example, the cross section of the gas channel C formed by the communication pipe 24 may have a circular shape or a non-circular shape such as rectangular or polygonal shapes. As shown in FIG. 2A, the communication pipe 24 may include a channel bent at right angles without continuous change of curvature of the gas channel C, or as shown in FIG. 2B, the communication pipe 24 may include a curved channel in which the curvature of the gas channel C changes continuously or is constant. It may also be possible that the communication pipe 24 includes both “a channel without continuous change of curvature of the gas channel C” and “a curved channel.” When the communication pipe 24 includes a curved channel, the pressure loss may be reduced, and the gas (the inert gas, oxygen, etc.) can flow smoothly through the gas channel C formed by the communication pipe 24. Also, the substance of the communication pipe 24 may not be particularly limited Typically, the communication pipe 24 may be formed of a stainless steel (SUS) but may be formed of other metals or resins. In the examples shown in FIGS. 1, 2A, and 2B, the communication pipe 24 may be mounted on a wall portion (for example, a back wall portion) on which the gas supply unit 20 (the first blow unit 201 and the second blow unit 202) is installed. However, the position to mount the communication pipe 24 may not be particularly limited, and the communication pipe 24 may be mounted on other wall portions of the three-dimensional modeling apparatus 10. Further, as shown in FIGS. 2A and 2B, the communication pipe 24 in this example may extend outside the wall portion of the three-dimensional modeling apparatus 10, but may alternatively extend in the wall portion of the three-dimensional modeling apparatus 10.

The positions at which the communication pipe 24 may be connected and opened to the process chamber 12 and the elevation guide chambers 14 may not be particularly limited, but the communication pipe 24 may preferably be connected and opened to the process chamber 12 near the oxygen sensor 34. With this arrangement, the oxygen sensor 34 can appropriately sense the density of the oxygen gas flowing from the communication pipe 24 into the process chamber 12. Also, the communication pipe 24 may preferably be connected and opened to the building elevation guide chamber 143 (the elevation guide chambers 14) below a movement range R of the building elevation stage 153 (the elevation stages 15). With this arrangement, the communication pipe 24 may communicate between the process chamber 12 and the space below the movement range R of the building elevation stage 153 in the building elevation guide chamber 143.

The drive chamber 32 may contain at least a part of the elevation drive units 18. For example, when an elevation drive unit 18 includes a projecting portion having one end thereof fixed to an associated elevation stage 15 (the dispenser elevation stage 151, the collection elevation stage 152, or the building elevation stage 153) and capable of projecting by a varied distance, and a motor (for example, a stepping motor) for driving the projecting portion, the drive chamber 32 may contain the motor and a part of the other end of the projecting portion.

The controller 36 may be installed above the process chamber 12. The controller 36 may control the units in the three-dimensional modeling apparatus 10. For example, the controller 36 may control the elevation drive units 18 to raise or lower the elevation stages 15, control the horizontal movement of the application unit 26, control the laser beam emission of the emission unit 30, and control supply of the inert gas from the gas supply unit 20. In particular, the controller 36 in this mode may receive the sensing values from the oxygen sensor 34 and, when the oxygen sensor 34 senses an oxygen density higher than a threshold value, the controller 36 may stop the elevation operation of the elevation stages 15, the horizontal movement of the application unit 26, and the laser beam emission from the emission unit 30, suspend modeling of the three-dimensional object 5, and issue an error message to an operator visually or audibly.

As described above, in this mode, the communication pipe 24 may communicate between the process chamber 12 and the space below the building elevation stage 153 in the building elevation guide chamber 143. Thus, the gas (which may be oxygen in particular but may also be nitrogen that should be discharged in an argon gas environment) accumulated in the space below the building elevation stage 153 can be efficiently guided to the process chamber 12 through the communication pipe 24 and discharged out of the process chamber 12 through the gas discharge unit 22. Accordingly, the gas in the three-dimensional modeling apparatus 10 (particularly the space below the building elevation stage 153 in the building elevation guide chamber 143) can be efficiently replaced with the inert gas, thereby to prevent the oxygen gas from accumulating in the space below the building elevation stage 153.

Thus, the oxygen sensor 34 may no longer or seldom sense an oxygen density higher than a threshold value, and therefore, even in the case where modeling should be suspended when the oxygen sensor 34 senses an oxygen density higher than a threshold value, modeling may be no longer or seldom suspended unexpectedly.

Further, in this mode, the gas in the space below the building elevation stage 153 in the building elevation guide chamber 143 may be guided to the process chamber 12 through the communication pipe 24. Accordingly, the oxygen density in the space below the building elevation stage 153 can be observed indirectly by the oxygen sensor 34 provided in the process chamber 12, and therefore, there is no need of providing an oxygen sensor in the space below the building elevation stage 153 in the building elevation guide chamber 143.

In this mode, the opening of the communication pipe 24 (the elevation chamber opening 24b) may be provided below the movement range R of the building elevation stage 153. Therefore, the oxygen gas accumulating in the building elevation guide chamber 143 (particularly the space below the building elevation stage 153) can be efficiently discharged without narrowing the movement range R of the building elevation stage 153.

When the gas channel C of the communication pipe 24 has a curved channel, the gas can flow smoothly in the gas channel C, and the oxygen gas accumulating in the space below the building elevation stage 153 in the building elevation guide chamber 143 can be discharged efficiently. In addition to oxygen, nitrogen included in the remaining air can also be discharged in the same manner. This may also apply to other modes described below.

### <Second Mode>

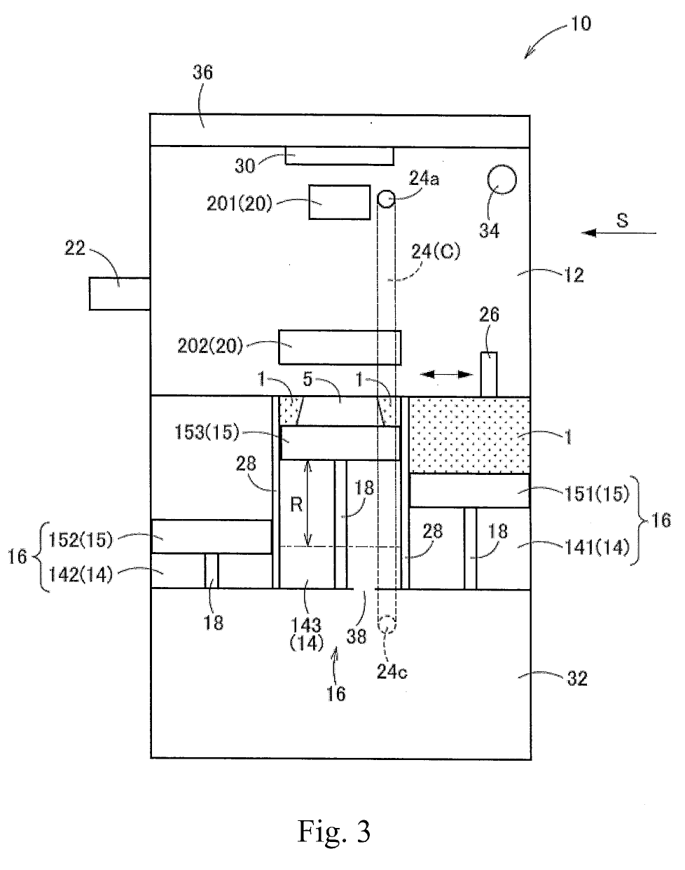

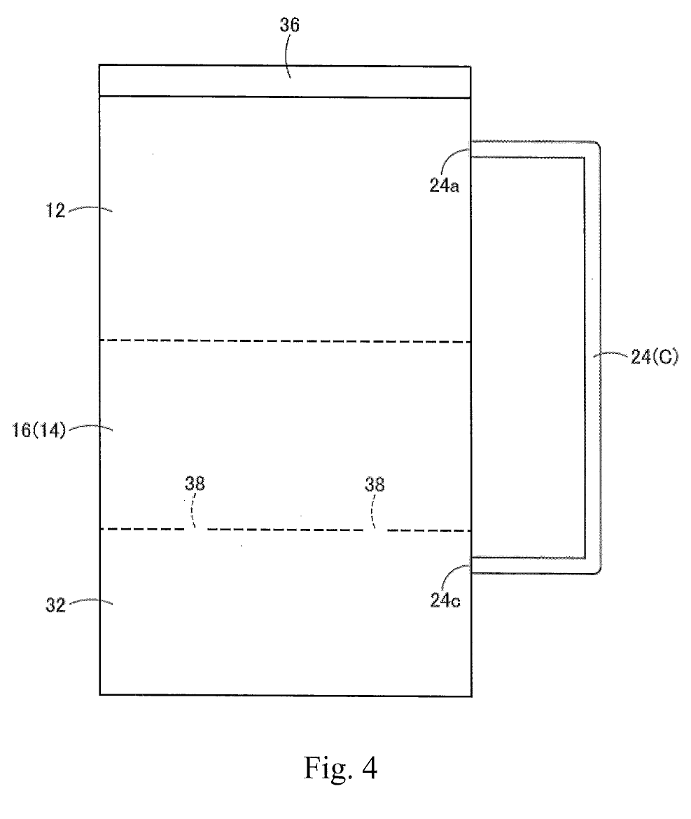

FIG. 3 shows a three-dimensional modeling apparatus 10 according to a second mode. FIG. 4 shows the three-dimensional modeling apparatus 10 of FIG. 3 as viewed from a side thereof (see the arrow S in FIG. 3).

In the three-dimensional modeling apparatus 10 according to this mode, the same or similar elements as in the three-dimensional modeling apparatus 10 according to the first mode described above (see FIGS. 1, 2A, and 2B) will be denoted by the same reference numerals and detailed descriptions thereof will be omitted.

The communication pipe 24 in this mode may connect to the process chamber 12 and the drive chamber 32, and communicate with the process chamber 12 via the process chamber opening 24a and communicate with the drive chamber 32 via a drive chamber opening 24c. The wall portion that may partition the elevation guide chambers 14 (the building elevation guide chamber 143 in this example) from the drive chamber 32 may include a plurality of communication apertures 38, and the drive chamber 32 may communicate with the elevation guide chambers 14 (the building elevation guide chamber 143) via these communication apertures 38. The communication apertures 38 may preferably be provided in such positions as to communicate between the drive chamber 32 and the space below the movement range R of the associated elevation stages 15 (the building elevation stage 153) in the elevation guide chambers 14 (the building elevation guide chamber 143).

In other respects, the three-dimensional modeling apparatus 10 according to this mode may be the same as that of the first mode described above.

The gas channel C that may communicate the process chamber 12 and the building elevation guide chamber 143 (particularly the space below the building elevation stage 153) may be constituted by the communication pipe 24 (including the process chamber opening 24a and the elevation chamber opening 24b), the drive chamber 32, and the communication apertures 38. Accordingly, the oxygen gas accumulating in the space below the building elevation stage 153 in the building elevation guide chamber 143 can be guided to the process chamber 12 through the gas channel C and discharged out of the three-dimensional modeling apparatus 10 through the gas discharge unit 22.

In this mode, in addition to the oxygen gas accumulating in the elevation guide chambers 14 (the building elevation guide chamber 143), the oxygen gas accumulating in the drive chamber 32 can be guided to the process chamber 12 and discharged out of the three-dimensional modeling apparatus 10 through the gas discharge unit 22. Thus, it may be possible to discharge the oxygen gas from the three-dimensional modeling apparatus 10 more securely and fill the three-dimensional modeling apparatus 10 with the inert gas.

It may also be possible that only one communication aperture 38 be provided. When a plurality of communication apertures 38 are provided, these communication apertures 38 may have either the same or different opening areas (channel areas).

### <Third Mode>

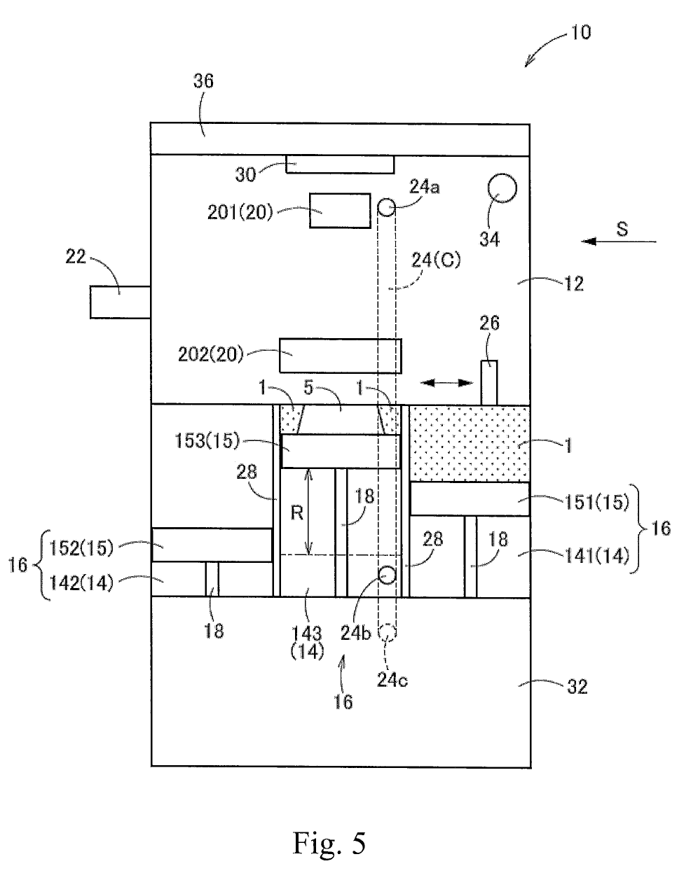

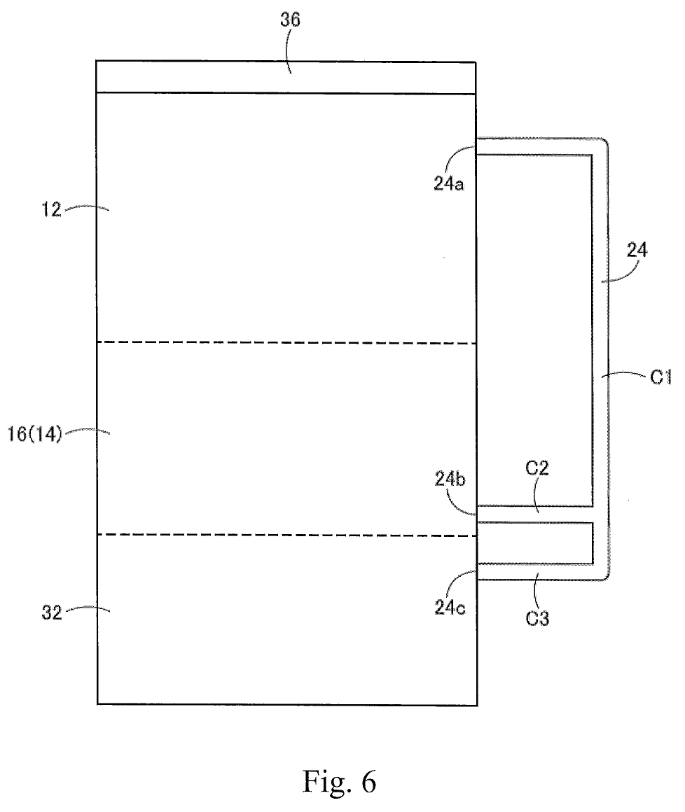

FIG. 5 shows a three-dimensional modeling apparatus 10 according to a third mode. FIG. 6 shows the three-dimensional modeling apparatus 10 of FIG. 5 as viewed from a side thereof (see the arrow S in FIG. 5).

In the three-dimensional modeling apparatus 10 according to this mode, the same or similar elements as in the three-dimensional modeling apparatus 10 according to the first mode described above (see FIGS. 1, 2A, and 2B) will be denoted by the same reference numerals and detailed descriptions thereof will be omitted.

The communication pipe 24 in this mode may communicate between the process chamber 12 and the elevation guide chambers 14 (the building elevation guide chamber 143 in this example) and further communicate between the process chamber 12 and the drive chamber 32. More specifically, the communication pipe 24 in this mode may be connected and opened to each of the process chamber 12, the elevation guide chambers 14 (the building elevation guide chamber 143), and the drive chamber 32. Therefore, the communication pipe 24 may include a process chamber communication channel C1 that communicates with the process chamber 12 via the process chamber opening 24a, an elevation guide chamber communication channel C2 that branches from the process chamber communication channel C1 and communicates with the elevation guide chambers 14 (the building elevation guide chamber 143) via the elevation chamber opening 24b, and a drive chamber communication channel C3 that branches from the process chamber communication channel C1 and communicates with the drive chamber 32 via the drive chamber opening 24c.

The cross-sectional areas (the channel areas) of the process chamber communication channel C1, the elevation guide chamber communication channel C2, and the drive chamber communication channel C3 may not be particularly limited. For example, when the cross-sectional area of the drive chamber communication channel C3 is larger than that of the elevation guide chamber communication channel C2, the gases may flow in or out through the drive chamber communication channel C3 more smoothly than through the elevation guide chamber communication channel C2, and therefore, it may be possible to efficiently facilitate inflow of the inert gas into the drive chamber 32 and discharge of the oxygen gas from the drive chamber 32. When the cross-sectional area of the drive chamber communication channel C3 is smaller than that of the process chamber communication channel C1, the gases may flow in or out through the process chamber communication channel C1 more smoothly than through the drive chamber communication channel C3, and therefore, it may be possible to efficiently facilitate inflow of the inert gas into the elevation guide chambers 14 (the building elevation guide chamber 143) and the drive chamber 32 and discharge of the oxygen gas from the elevation guide chambers 14 (the building elevation guide chamber 143) and the drive chamber 32. Further, when the cross-sectional areas of the channels are smaller in the order of the process chamber communication channel C1, the drive chamber communication channel C3, and the elevation guide chamber communication channel C2 (that is, the sectional area of the process chamber communication channel C1>the sectional area of the drive chamber communication channel C3>the sectional area of the elevation guide chamber communication channel C2), it may be possible to maintain a good balance between the inflow of the inert gas from the process chamber 12 into the building elevation guide chamber 143 and the drive chamber 32, and the outflow of the oxygen gas from the building elevation guide chamber 143 and the drive chamber 32 to the process chamber 12. With this arrangement, the oxygen gas discharged from the drive chamber 32 may be prevented from flowing into the building elevation guide chamber 143 and may be delivered to the process chamber 12.

In other respects, the three-dimensional modeling apparatus 10 according to this mode may be the same as that of the first mode described above.

In this mode, it may be possible to prevent the oxygen gas from accumulating in any of the elevation guide chambers 14 (the building elevation guide chamber 143) and the drive chamber 32, so as to discharge the oxygen gas from the three-dimensional modeling apparatus 10 more securely and fill the three-dimensional modeling apparatus 10 with the inert gas.

### <Fourth Mode>

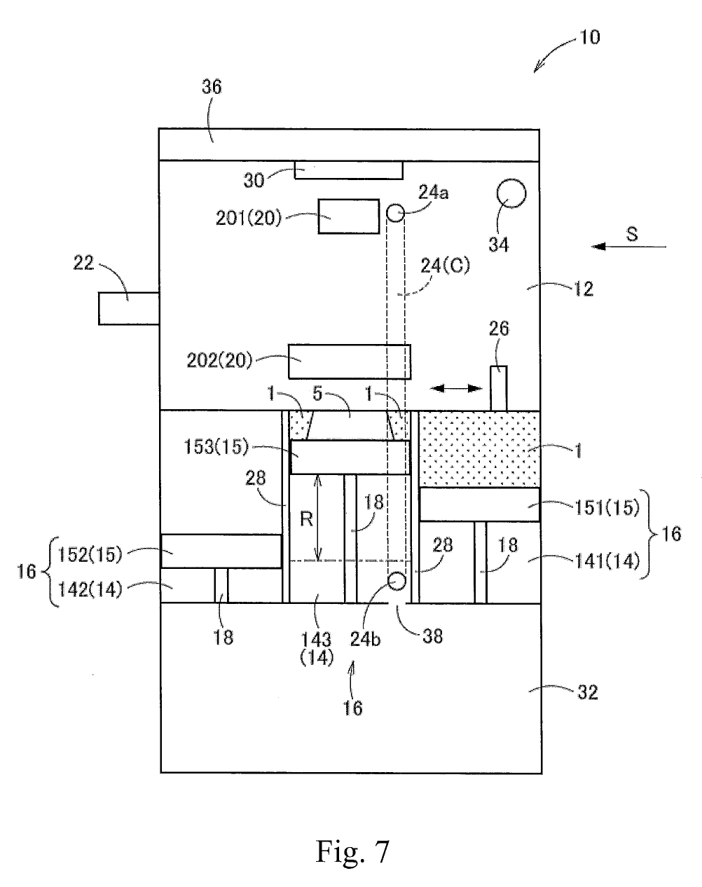

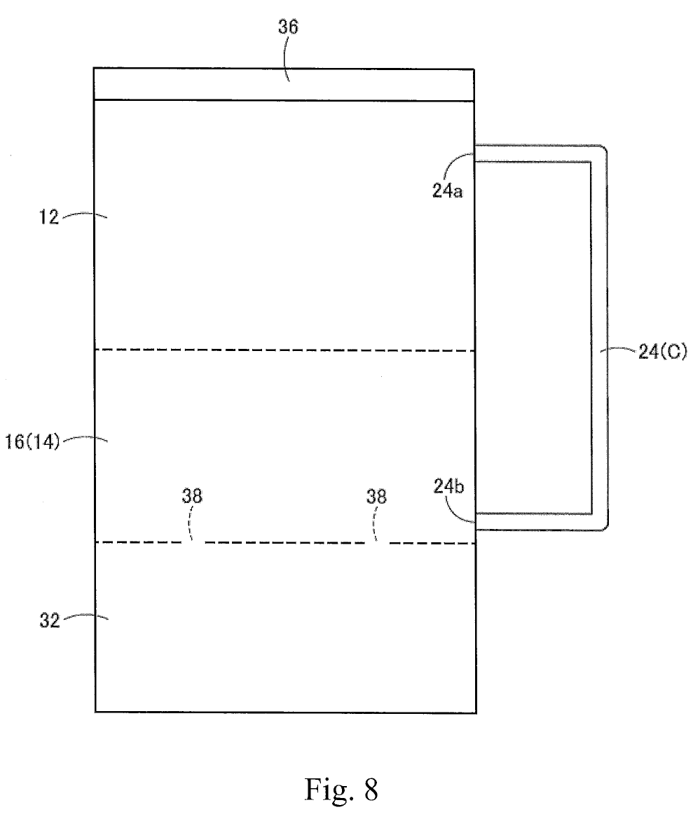

FIG. 7 shows a three-dimensional modeling apparatus 10 according to a fourth mode. FIG. 8 shows the three-dimensional modeling apparatus 10 of FIG. 7 as viewed from a side thereof (see the arrow S in FIG. 7).

In the three-dimensional modeling apparatus 10 according to this mode, the same or similar elements as in the three-dimensional modeling apparatus 10 according to the first mode described above (see FIGS. 1, 2A, and 2B) will be denoted by the same reference numerals and detailed descriptions thereof will be omitted.

In this mode, the wall portion that may partition the elevation guide chambers 14 (the building elevation guide chamber 143 in this example) from the drive chamber 32 may include a plurality of communication apertures 38, and the drive chamber 32 may communicate with the elevation guide chambers 14 (particularly the space below the building elevation stage 153 in the building elevation guide chamber 143) via these communication apertures 38.

In other respects, the three-dimensional modeling apparatus 10 according to this mode may be the same as that of the first mode described above.

In this mode, the communication apertures 38 may communicate between the drive chamber 32 and the elevation guide chambers 14 (the building elevation guide chamber 143). Therefore, it may be possible to prevent the oxygen gas from accumulating in any of the elevation guide chambers 14 (the building elevation guide chamber 143) and the drive chamber 32 more securely, so as to fill the three-dimensional modeling apparatus 10 with the inert gas.

In particular, when an inert gas having a larger specific weight than oxygen, such as argon, is used, the inert gas can efficiently flow into the drive chamber 32 via the communication apertures 38. The plurality of communication apertures 38 may be divided into communication apertures 38 that communicate primarily the gas flowing from the building elevation guide chamber 143 to the drive chamber 32 and communication apertures 38 that communicate primarily the gas flowing from the drive chamber 32 to the building elevation guide chamber 143, so as to efficiently discharge the oxygen gas and fill the inert gas.

### <Fifth Mode>

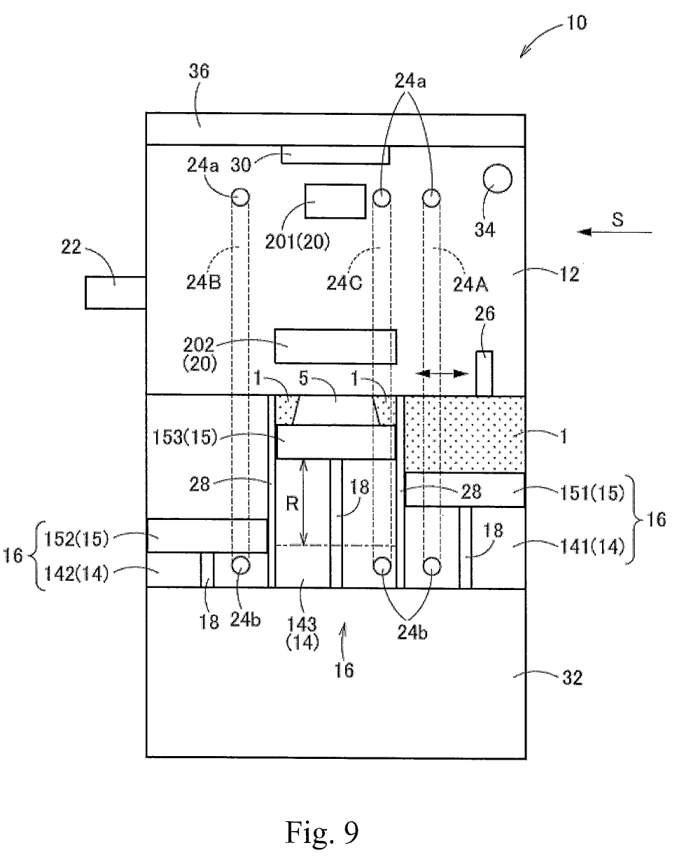

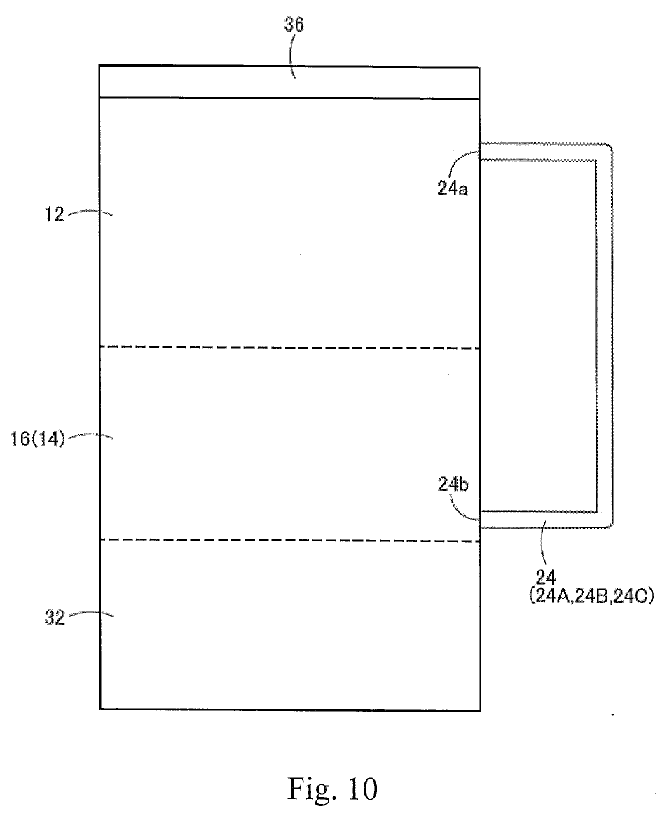

FIG. 9 shows a three-dimensional modeling apparatus 10 according to a fifth mode. FIG. 10 shows the three-dimensional modeling apparatus 10 of FIG. 9 as viewed from a side thereof (see the arrow S in FIG. 9).

In the three-dimensional modeling apparatus 10 according to this mode, the same or similar elements as in the three-dimensional modeling apparatus 10 according to the first mode described above (see FIGS. 1, 2A, and 2B) will be denoted by the same reference numerals and detailed descriptions thereof will be omitted.

In this mode, a plurality of communication pipes (a first communication pipe 24A, a second communication pipe 24B, and a third communication pipe 24C) may be provided. These communication pipes 24A, 24B, and 24C may communicate between each of the plurality of elevation guide chambers 14 (the dispenser elevation guide chamber 141, the collection elevation guide chamber 142, and the building elevation guide chamber 143) and the process chamber 12. More specifically, the first communication pipe 24A may connect to the process chamber 12 and the dispenser elevation guide chamber 141, and may communicate between the process chamber 12 and the dispenser elevation guide chamber 141 via the process chamber opening 24a and the elevation chamber opening 24b. The second communication pipe 24B may connect to the process chamber 12 and the collection elevation guide chamber 142, and may communicate between the process chamber 12 and the collection elevation guide chamber 142 via the process chamber opening 24a and the elevation chamber opening 24b. The third communication pipe 24C may connect to the process chamber 12 and the building elevation guide chamber 143, and may communicate between the process chamber 12 and the building elevation guide chamber 143 via the process chamber opening 24a and the elevation chamber opening 24b.

The positions of the process chamber openings 24a and the elevation chamber openings 24b for the communication pipes 24A, 24B, and 24C may not be particularly limited. As in the first mode described above, the process chamber openings 24a for the communication pipes 24A, 24B, and 24C may preferably be positioned closer to the oxygen sensor 34 than to the position where the gas supply unit 20 (the first blow unit 201 and the second blow unit 202) supplies an inert gas in the process chamber 12. The elevation chamber openings 24b for the communication pipes 24A, 24B, and 24C may preferably be positioned below the movement range R of the associated one of the elevation stages 15 (the dispenser elevation stage 151, the collection elevation stage 152, and the building elevation stage 153).

The plurality of communication pipes 24A, 24B, and 24C in this mode may communicate with the process chamber 12 through the same wall portion among the plurality of wall portions constituting the process chamber 12, and may communicate with the associated one of the elevation guide chambers 14 (the dispenser elevation guide chamber 141, the collection elevation guide chamber 142, and the building elevation guide chamber 143) through the wall portions on the same side among the plurality of wall portions constituting the elevation guide chambers 14.

In other respects, the three-dimensional modeling apparatus 10 according to this mode may be the same as that of the first mode described above.

In this mode, the oxygen gas accumulating in the plurality of elevation guide chambers 14 (the dispenser elevation guide chamber 141, the collection elevation guide chamber 142, and the building elevation guide chamber 143) can be efficiently discharged via the plurality of communication pipes 24A, 24B, and 24C, the process chamber 12, and the gas discharge unit 22.

### <Sixth Mode>

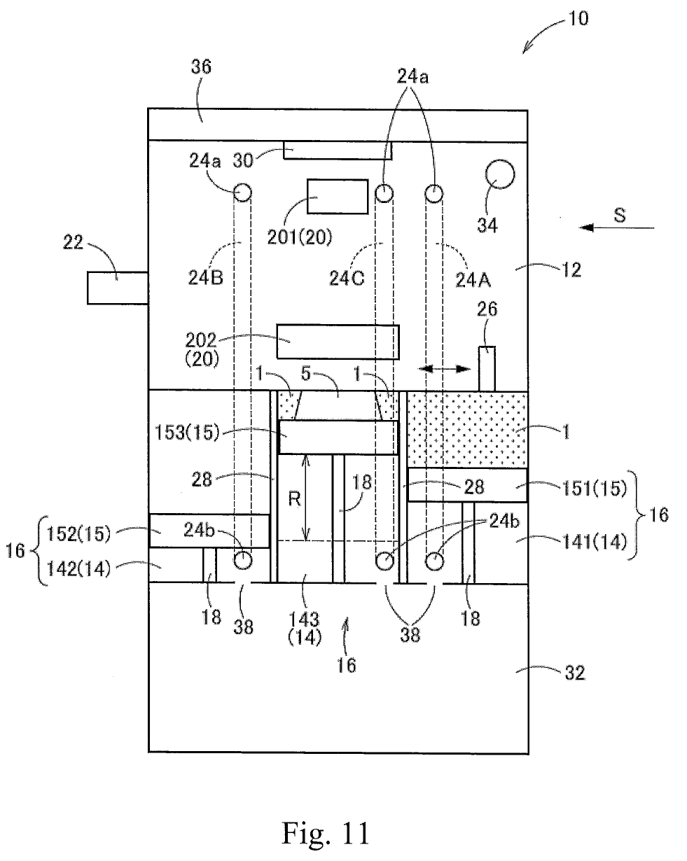

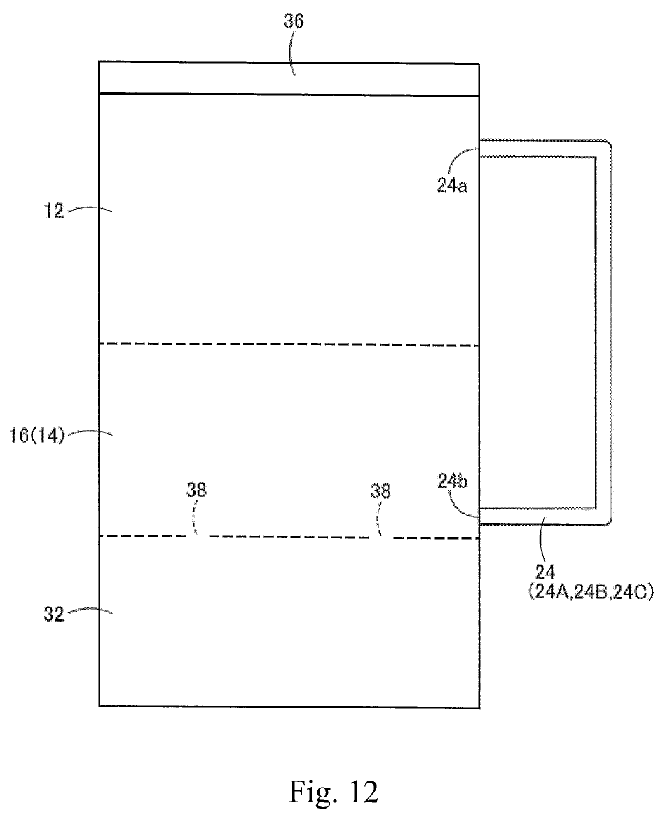

FIG. 11 shows a three-dimensional modeling apparatus 10 according to a sixth mode. FIG. 12 shows the three-dimensional modeling apparatus 10 of FIG. 11 as viewed from a side thereof (see the arrow S in FIG. 11).

In the three-dimensional modeling apparatus 10 according to this mode, the same or similar elements as in the three-dimensional modeling apparatus 10 according to the fifth mode described above (see FIGS. 9 and 10) will be denoted by the same reference numerals and detailed descriptions thereof will be omitted.

In this mode, a plurality of communication apertures 38 may be provided to communicate between each of the plurality of elevation guide chambers 14 (the dispenser elevation guide chamber 141, the collection elevation guide chamber 142, and the building elevation guide chamber 143) and the drive chamber 32. Each of the elevation guide chambers 14 may be provided with two communication apertures 38, and thus six communication apertures may be provided in total.

In other respects, the three-dimensional modeling apparatus 10 according to this mode may be the same as that of the fifth mode described above.

In this mode, the oxygen gas accumulating in the plurality of elevation guide chambers 14 (the dispenser elevation guide chamber 141, the collection elevation guide chamber 142, and the building elevation guide chamber 143) can be discharged, and in addition, the oxygen gas accumulating in the drive chamber 32 can also be efficiently discharged via the communication apertures 38, the elevation guide chambers 14, the communication pipes 24, the process chamber 12, and the gas discharge unit 22.

The communication apertures 38 may not necessarily communicate between all of the plurality of elevation guide chambers 14 and the drive chamber 32 but may be configured only to communicate between at least one of the plurality of elevation guide chambers 14 and the drive chamber 32.

### <Seventh Mode>

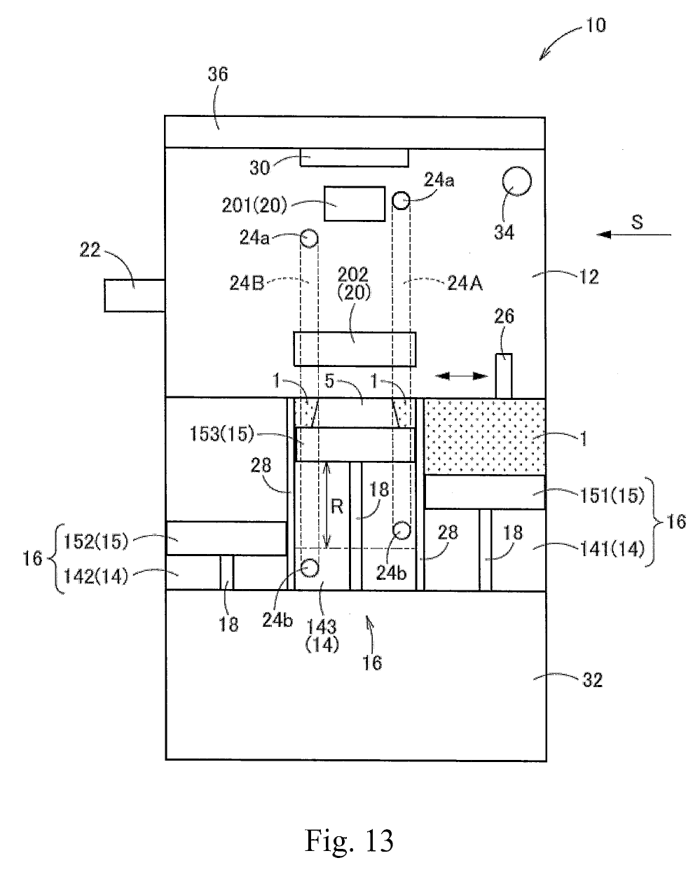

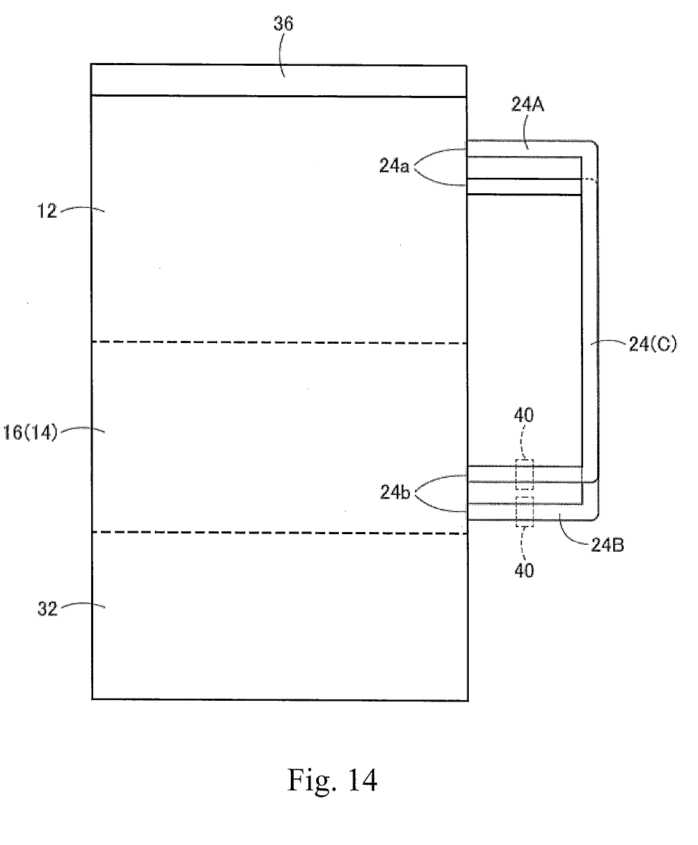

FIG. 13 shows a three-dimensional modeling apparatus 10 according to a seventh mode. FIG. 14 shows the three-dimensional modeling apparatus 10 of FIG. 13 as viewed from a side thereof (see the arrow S in FIG. 13).

In the three-dimensional modeling apparatus 10 according to this mode, the same or similar elements as in the three-dimensional modeling apparatus 10 according to the first mode described above (see FIGS. 1, 2A, and 2B) will be denoted by the same reference numerals and detailed descriptions thereof will be omitted.

In this mode, a plurality of communication pipes (two communication pipes in this example) including a first communication pipe 24A and a second communication pipe 24B may be provided. The first communication pipe 24A and the second communication pipe 24B may connect to the process chamber 12 via the process chamber openings 24a and may also connect to the same elevation guide chamber 14 (the building elevation guide chamber 143 in this example) via the elevation chamber openings 24b.

The position where the first communication pipe 24A is opened to the building elevation guide chamber 143 (that is, the position of the elevation chamber opening 24b for the first communication pipe 24A) may be above the position where the second communication pipe 24B is opened to the building elevation guide chamber 143 (that is, the position of the elevation chamber opening 24b for the second communication pipe 24B). The elevation chamber openings 24b for the first communication pipe 24A and the second communication pipe 24B may be positioned below the movement range R of the associated one of the elevation stages 15 (the building elevation stage 153 in this example). The position where the first communication pipe 24A is opened to the process chamber 12 (that is, the position of the process chamber opening 24a for the first communication pipe 24A) may be above the position where the second communication pipe 24B is opened to the process chamber 12 (that is, the position of the process chamber opening 24a for the second communication pipe 24B).

The process chamber opening 24a for the first communication pipe 24A may be opened to the process chamber 12 at a position closer to the oxygen sensor 34 than to the position where the gas supply unit 20 (the first blow unit 201 and the second blow unit 202) supplies an inert gas in the process chamber 12.

The cross-sectional areas of the channels in the first communication pipe 24A and the second communication pipe 24B may not be particularly limited. The cross-sectional area of the channel in the first communication pipe 24A may be either larger or smaller than that of the channel in the second communication pipe 24B. When the cross-sectional area of the channel in the first communication pipe 24A is larger than that of the channel in the second communication pipe 24B, the oxygen gas accumulating in the building elevation guide chamber 143 can be efficiently guided to the process chamber 12 via the first communication pipe 24A, with the inert gas such as argon having a larger specific weight than oxygen. Conversely, when the cross-sectional area of the channel in the first communication pipe 24A is smaller than that of the channel in the second communication pipe 24B, the inert gas can be efficiently guided to the building elevation guide chamber 143 via the second communication pipe 24B, with the inert gas such as nitrogen having a smaller specific weight than oxygen. As a result, the oxygen gas accumulating in the building elevation guide chamber 143 can be efficiently forced into the process chamber 12.

Further, at least one of the first communication pipe 24A and the second communication pipe 24B may be provided with a channel adjusting unit 40 that can adjust the degree of opening of the channel (the channel area). As the channel adjusting unit 40 adjusts the channel area, the conditions for passing the gas through the first communication pipe 24A and the second communication pipe 24B can be altered flexibly, thereby to discharge the oxygen gas from the three-dimensional modeling apparatus 10 more efficiently.

In other respects, the three-dimensional modeling apparatus 10 according to this mode may be the same as that of the first mode described above.

In this mode, the oxygen gas accumulating in the elevation guide chambers 14 (the building elevation guide chamber 143) can be efficiently discharged via the plurality of communication pipes (the first communication pipe 24A and the second communication pipe 24B). As in this mode, use of the plurality of communication pipes 24A, 24B, each having a small channel area, may provide a large channel area of the communication pipes in total. Further, use of the plurality of communication pipes 24A, 24B may increase the freedom in arrangement of the communication pipes, making it possible to discharge the oxygen gas from the building elevation guide chamber 143 efficiently and fill the building elevation guide chamber 143 with the inert gas.

The first communication pipe 24A and the second communication pipe 24B may be opened to the building elevation guide chamber 143 and the process chamber 12 at different positions, such that one of the first communication pipe 24A and the second communication pipe 24B may serve mainly as a supply line of the inert gas and the other may serve mainly as a discharge line of the oxygen gas, making it possible to efficiently discharge the oxygen gas and supply the inert gas.

Of the plurality of communication pipes 24A, 24B, the one positioned higher (the first communication pipe 24A in this example) may have a channel area larger than that of the other positioned lower (the second communication pipe 24B in this example), such that the oxygen gas can be discharged efficiently with the inert gas such as argon.

The plurality of communication pipes 24A, 24B may be provided on the same wall portion, such that these communication pipes 24A, 24B can be readily maintained.

### <Eighth Mode>

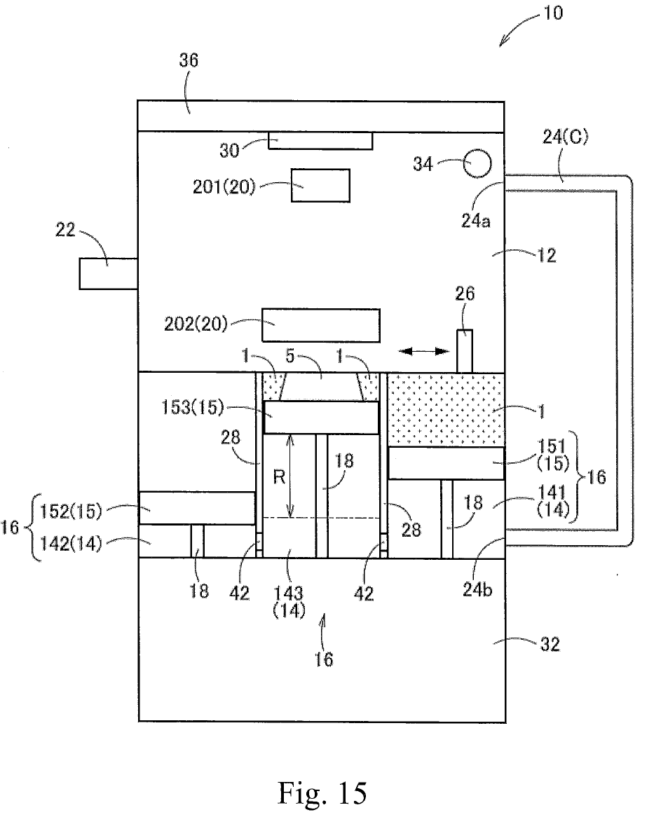

FIG. 15 shows a three-dimensional modeling apparatus 10 according to an eighth mode.

In the three-dimensional modeling apparatus 10 according to this mode, the same or similar elements as in the three-dimensional modeling apparatus 10 according to the first mode described above (see FIGS. 1, 2A, and 2B) will be denoted by the same reference numerals and detailed descriptions thereof will be omitted.

The communication pipe 24 in this mode may communicate between at least one of the plurality of elevation guide chambers 14 (one elevation guide chamber 14 (the dispenser elevation guide chamber 141) in this example) and the process chamber 12. Each of the partition walls 28 may have a communication hole 42 formed therein, and any two elevation guide chambers 14 arranged adjacent to each other (in this example, the dispenser elevation guide chamber 141 and the building elevation guide chamber 143, or the collection elevation guide chamber 142 and the building elevation guide chamber 143) may communicate with each other via the communication hole 42.

Each of the communication holes 42 may be positioned below the movement ranges R of the elevation stages 15 to be raised and lowered in the elevation guide chambers 14 partitioned with the partition wall including the communication hole 42 (that is, the elevation guide chambers 14 adjacent to each other). The communication hole 42 provided between the dispenser elevation guide chamber 141 and the building elevation guide chamber 143 may be positioned below the movement ranges R of the dispenser elevation stage 151 and the building elevation stage 153. The communication hole 42 provided between the collection elevation guide chamber 142 and the building elevation guide chamber 143 may be positioned below the movement ranges R of the collection elevation stage 152 and the building elevation stage 153. In this mode, the communication hole 42 provided between the dispenser elevation guide chamber 141 and the building elevation guide chamber 143 and the communication hole 42 provided between the collection elevation guide chamber 142 and the building elevation guide chamber 143 may have the same opening cross-sectional area (channel area).

Each of the partition walls 28 between the dispenser elevation guide chamber 141 and the building elevation guide chamber 143 and between the collection elevation guide chamber 142 and the building elevation guide chamber 143 may include a plurality of communication holes 42. That is, a plurality of communication holes 42 may be provided between the dispenser elevation guide chamber 141 and the building elevation guide chamber 143, and a plurality of communication holes 42 may be provided between the collection elevation guide chamber 142 and the building elevation guide chamber 143.

In other respects, the three-dimensional modeling apparatus 10 according to this mode may be the same as that of the first mode described above.

In this mode, the dispenser elevation guide chamber 141, the building elevation guide chamber 143, and the collection elevation guide chamber 142 may communicate with each other via the communication holes 42. Therefore, the inert gas supplied from the communication pipe 24 to the dispenser elevation guide chamber 141 may be delivered to the building elevation guide chamber 143 and the collection elevation guide chamber 142 via the communication holes 42. The oxygen gas accumulating in the building elevation guide chamber 143 and the collection elevation guide chamber 142 can be moved to the dispenser elevation guide chamber 141 via the communication holes 42 and discharged via the communication pipe 24, the process chamber 12, and the gas discharge unit 22.

Therefore, in this mode, it may be possible to efficiently discharge the oxygen gas accumulating in the plurality of elevation guide chambers 14 and fill the three-dimensional modeling apparatus 10 with the inert gas, while minimizing the space for installation of the communication pipe 24.

In the example shown in FIG. 15, the communication pipe 24 may be connected to the dispenser elevation guide chamber 141, which may be positioned in one end of the plurality of elevation guide chambers 14 arranged adjacent to each other. Alternatively, it may also be possible that the communication pipe 24 be connected to other elevation guide chambers 14 (the collection elevation guide chamber 142 and/or the building elevation guide chamber 143).

### <Ninth Mode>

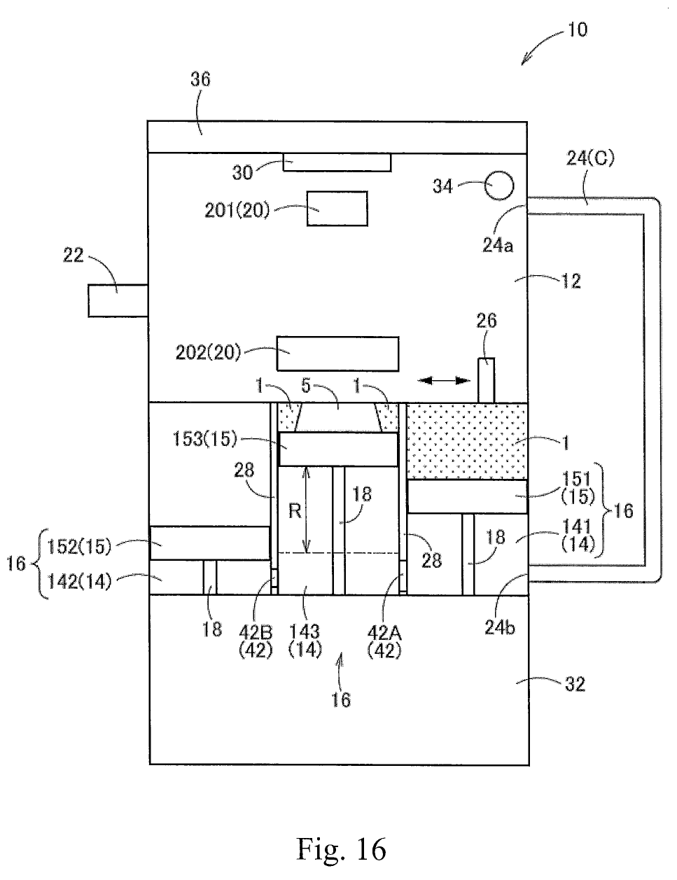

FIG. 16 shows a three-dimensional modeling apparatus 10 according to a ninth mode.

In the three-dimensional modeling apparatus 10 according to this mode, the same or similar elements as in the three-dimensional modeling apparatus 10 according to the eighth mode described above (see FIG. 15) will be denoted by the same reference numerals and detailed descriptions thereof will be omitted.

In this mode, the first communication hole 42A provided between the dispenser elevation guide chamber 141 and the building elevation guide chamber 143 and the second communication hole 42B provided between the collection elevation guide chamber 142 and the building elevation guide chamber 143 may have different opening cross-sectional areas (channel areas). In particular, the opening cross-sectional area of the first communication hole 42A that communicates between the elevation guide chamber 14 (the dispenser elevation guide chamber 141 in this example) to which the communication pipe 24 may be connected and the elevation guide chamber 14 (the building elevation guide chamber 143 in this example) to which the communication pipe 24 may not be connected may be larger than the opening cross-sectional area of the second communication hole 42B that communicates between the elevation guide chambers 14 (the collection elevation guide chamber 142 and the building elevation guide chamber 143) to which the communication pipe 24 may not be connected.

In other respects, the three-dimensional modeling apparatus 10 according to this mode may be the same as that of the eighth mode described above.

In this mode, the inert gas delivered to the dispenser elevation guide chamber 141 from the communication pipe 24 can be readily supplied to the building elevation guide chamber 143, and the oxygen gas accumulating in the building elevation guide chamber 143 can be efficiently discharged to the dispenser elevation guide chamber 141.

It may also be possible to provide a plurality of first communication holes 42A and/or a plurality of second communication holes 42B. That is, a plurality of first communication holes 42A may be provided in the partition wall 28 between the dispenser elevation guide chamber 141 and the building elevation guide chamber 143, and a plurality of second communication holes 42B may be provided in the partition wall 42B between the collection elevation guide chamber 142 and the building elevation guide chamber 143. In this arrangement, it may be possible that the opening cross-sectional area of one of the first communication holes 42A is not larger than the opening cross-sectional area of one of the second communication holes 42B. The same effect as in this mode can be expected when the sum of the opening cross-sectional areas of the one or more first communication holes 42A provided between the dispenser elevation guide chamber 141 and the building elevation guide chamber 143 is larger than the sum of the opening cross-sectional areas of the one or more second communication holes 42B provided between the collection elevation guide chamber 142 and the building elevation guide chamber 143. Accordingly, even when the opening cross-sectional area of one of the first communication holes 42A is not larger than the opening cross-sectional area of one of the second communication holes 42B, the number of the first communication holes 42A may be larger than the number of the second communication holes 42B such that the sum of the opening cross-sectional areas of the first communication holes 42A is larger than the sum of the opening cross-sectional areas of the second communication holes 42B.

Further, the relationship between the opening cross-sectional areas of the first communication pipe 24A and the second communication pipe 24B may not be limited to the above examples. For example, the sum of the opening cross-sectional areas of the one or more first communication pipes 24A may be smaller than the sum of the opening cross-sectional areas of the one or more second communication pipes 24B.

### <Tenth Mode>

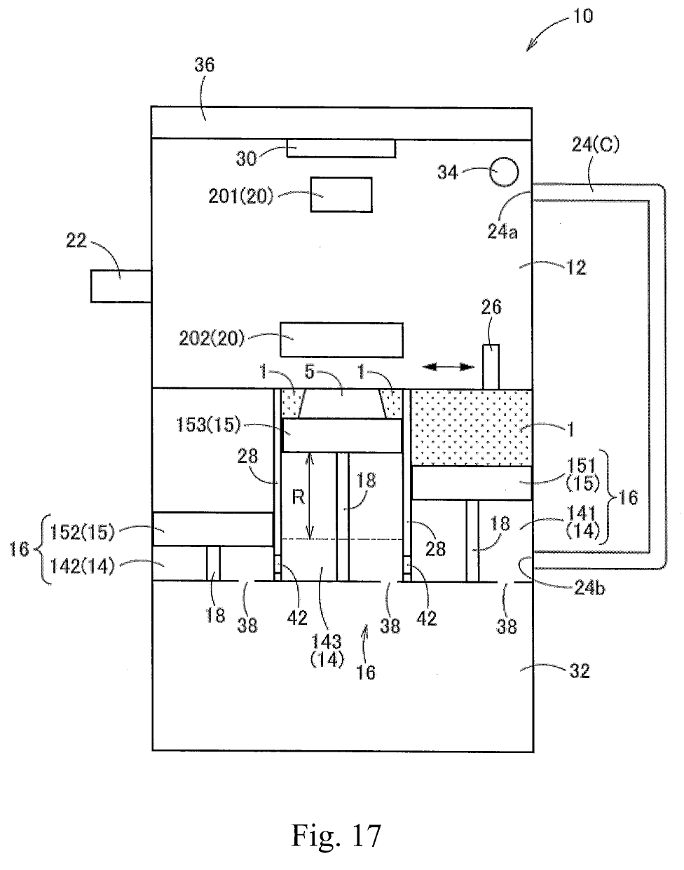

FIG. 17 shows a three-dimensional modeling apparatus 10 according to a tenth mode.

In the three-dimensional modeling apparatus 10 according to this mode, the same or similar elements as in the three-dimensional modeling apparatus 10 according to the eighth mode described above (see FIG. 15) will be denoted by the same reference numerals and detailed descriptions thereof will be omitted.

In this mode, a plurality of communication apertures 38 may be provided to communicate between at least one of the plurality of elevation guide chambers 14 (the dispenser elevation guide chamber 141, the building elevation guide chamber 143, and the collection elevation guide chamber 142) (all the elevation guide chambers 14 in this example) and the drive chamber 32. That is, a communication aperture 38 may be provided in each of the wall portion partitioning the dispenser elevation guide chamber 141 from the drive chamber 32, the wall portion partitioning the building elevation guide chamber 143 from the drive chamber 32, and the wall portion partitioning the collection elevation guide chamber 142 from the drive chamber 32.

In other respects, the three-dimensional modeling apparatus 10 according to this mode may be the same as that of the eighth mode described above.

In this mode, in addition to the oxygen gas accumulating in the elevation guide chambers 14, the oxygen gas accumulating in the drive chamber 32 can be guided to the process chamber 12 and discharged out of the three-dimensional modeling apparatus 10 through the gas discharge unit 22.

It may also be possible that only one communication aperture 38 be provided. When a plurality of communication apertures 38 are provided, these communication apertures 38 may have either the same or different opening areas (channel areas). Further, it may be possible that the cross-sectional area of the first communication hole 42A is not necessarily the same as that of the second communication hole 42B.

### <Eleventh Mode>

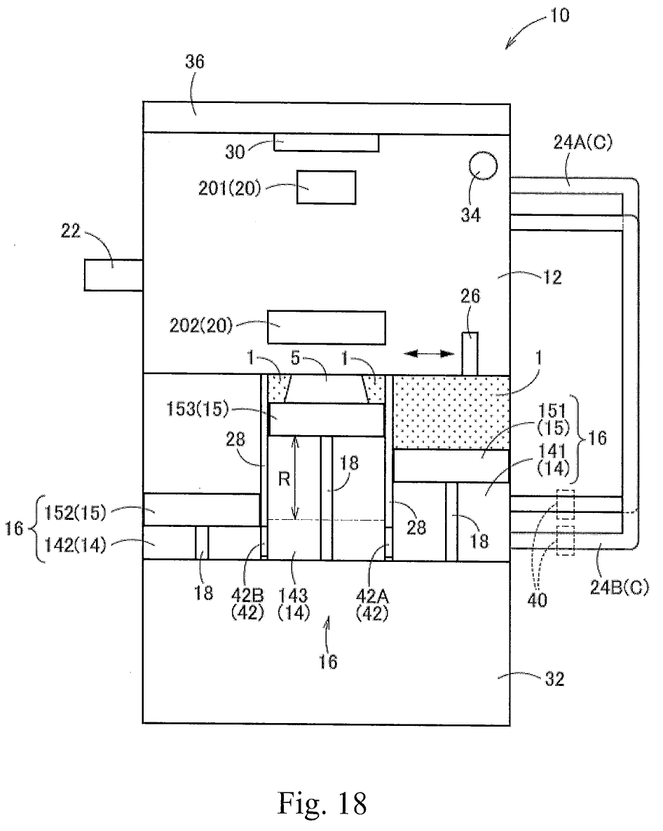

FIG. 18 shows a three-dimensional modeling apparatus 10 according to an eleventh mode.

In the three-dimensional modeling apparatus 10 according to this mode, the same or similar elements as in the three-dimensional modeling apparatus 10 according to the eighth mode described above (see FIG. 15) will be denoted by the same reference numerals and detailed descriptions thereof will be omitted.

In this mode, a plurality of communication pipes (two communication pipes in this example) including a first communication pipe 24A and a second communication pipe 24B may be provided. The first communication pipe 24A and the second communication pipe 24B may communicate between at least one of the plurality of elevation guide chambers 14 (the dispenser elevation guide chamber 141 in this example) and the process chamber 12. The first communication pipe 24A and the second communication pipe 24B may communicate with the process chamber 12 through the same wall portion among the plurality of wall portions constituting the process chamber 12, and may communicate with the associated one of the elevation guide chambers 14 (the dispenser elevation guide chamber 141 in this example) through the same wall portion among the plurality of wall portions constituting the elevation guide chamber 14 (the dispenser elevation guide chamber 141). The first communication pipe 24A and the second communication pipe 24B may be provided on the same wall portion, so as to reduce the space for installation.

The position where the first communication pipe 24A is opened to the elevation guide chamber 14 (the dispenser elevation guide chamber 141) (that is, the position of the elevation chamber opening 24b for the first communication pipe 24A) may be above the position where the second communication pipe 24B is opened to the elevation guide chamber 14 (the dispenser elevation guide chamber 141) (that is, the position of the elevation chamber opening 24b for the second communication pipe 24B). The position where the first communication pipe 24A is opened to the process chamber 12 (that is, the position of the process chamber opening 24a for the first communication pipe 24A) may be above the position where the second communication pipe 24B is opened to the process chamber 12 (that is, the position of the process chamber opening 24a for the second communication pipe 24B).

The process chamber opening 24a for the first communication pipe 24A may be opened to the process chamber 12 at a position closer to the oxygen sensor 34 than to the position where the gas supply unit 20 (the first blow unit 201 and the second blow unit 202) supplies an inert gas in the process chamber 12. In this example, the process chamber opening 24a for the second communication pipe 24B may also be opened to the process chamber 12 at a position closer to the oxygen sensor 34 than to the position where the gas supply unit 20 (the first blow unit 201 and the second blow unit 202) supplies an inert gas in the process chamber 12.

The cross-sectional areas of the channels (the channel areas) in the first communication pipe 24A and the second communication pipe 24B may not be particularly limited. The cross-sectional area of the channel in the first communication pipe 24A may be the same as or larger or smaller than that of the channel in the second communication pipe 24B. Further, at least one of the first communication pipe 24A and the second communication pipe 24B may be provided with a channel adjusting unit 40 that can adjust the degree of opening of the channel (the channel area). For example, the channel area of the first communication pipe 24A may be larger than that of the second communication pipe 24B such that the conduit resistance of the first communication pipe 24A is smaller.

In other respects, the three-dimensional modeling apparatus 10 according to this mode may be the same as that of the eighth mode described above.

In this mode, the oxygen gas accumulating in the elevation guide chambers 14 (the dispenser elevation guide chamber 141, the building elevation guide chamber 143, and the collection elevation guide chamber 142) can be efficiently discharged via the first communication pipe 24A and the second communication pipe 24B.

It may be possible that the cross-sectional area of the first communication hole 42A is not necessarily the same as that of the second communication hole 42B. For example, the cross-sectional area of the second communication hole 42B that communicates between the collection elevation guide chamber 142 (the second elevation guide chamber) and the building elevation guide chamber 143 (the third elevation guide chamber) may be larger than the cross-sectional area of the first communication hole 42A that communicates between the dispenser elevation guide chamber 141 (the first elevation guide chamber) and the building elevation guide chamber 143. In this arrangement, the inert gas supplied to the dispenser elevation guide chamber 141 via the first communication pipe 24A and the second communication pipe 24B can be efficiently delivered to the collection elevation guide chamber 142, and the oxygen gas accumulating not only in the dispenser elevation guide chambers 141 but also the collection elevation guide chamber 142 and the building elevation guide chamber 143 can be efficiently discharged. The cross-sectional areas (the channel areas) of the first communication hole 42A and the second communication hole 42B may be larger than the channel areas of the first communication pipe 24A and the second communication pipe 24B. Thus, the cross-sectional areas of the first communication hole 42A and the second communication hole 42B may be large, such that the gases may flow in or out smoothly between the elevation guide chambers 14 and the oxygen gas accumulating in the elevation guide chambers 14 can be replaced with the inert gas smoothly.

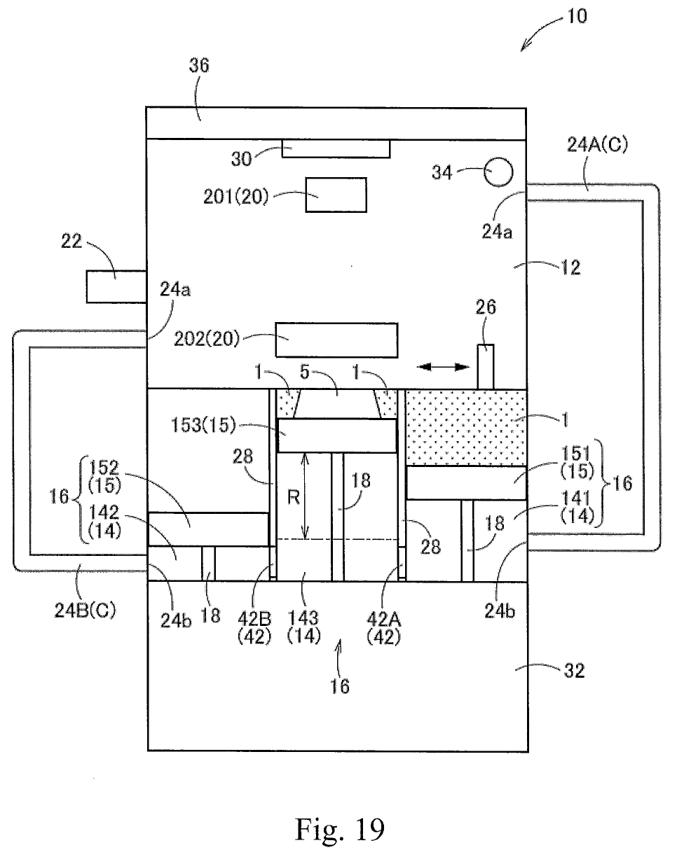

The first communication pipe 24A and the second communication pipe 24B may not necessarily connect to the same elevation guide chamber 14 (the dispenser elevation guide chamber 141 in the above example) but may connect to different elevation guide chambers 14. For example, as shown in FIG. 19, one of the first communication pipe 24A and the second communication pipe 24B (the first communication pipe 24A in the example shown in FIG. 19) may connect to the dispenser elevation guide chamber 141 and the process chamber 12, and the other (the second communication pipe 24B in the example shown in FIG. 19) may connect to the collection elevation guide chamber 142 and the process chamber 12. In this arrangement, the collection elevation guide chamber 142 provided in one end of the plurality of elevation guide chambers 14 arranged in an array, and the dispenser elevation guide chamber 141 provided in the other end may connect to the process chamber 12, and the elevation guide chambers 14 arranged adjacent to each other may communicate with each other via the communication holes 42. This arrangement may enable smooth inflow of the inert gas into the elevation guide chambers 14 and smooth discharge of the oxygen gas from the elevation guide chambers 14.

The first communication pipe 24A and the second communication pipe 24B may communicate with the process chamber 12 through different wall portions among the plurality of wall portions constituting the process chamber 12, and may communicate with the associated one of the elevation guide chambers 14 (the dispenser elevation guide chamber 141 in this example) through the different wall portions among the plurality of wall portions constituting the elevation guide chamber 14.

### <Twelfth Mode>

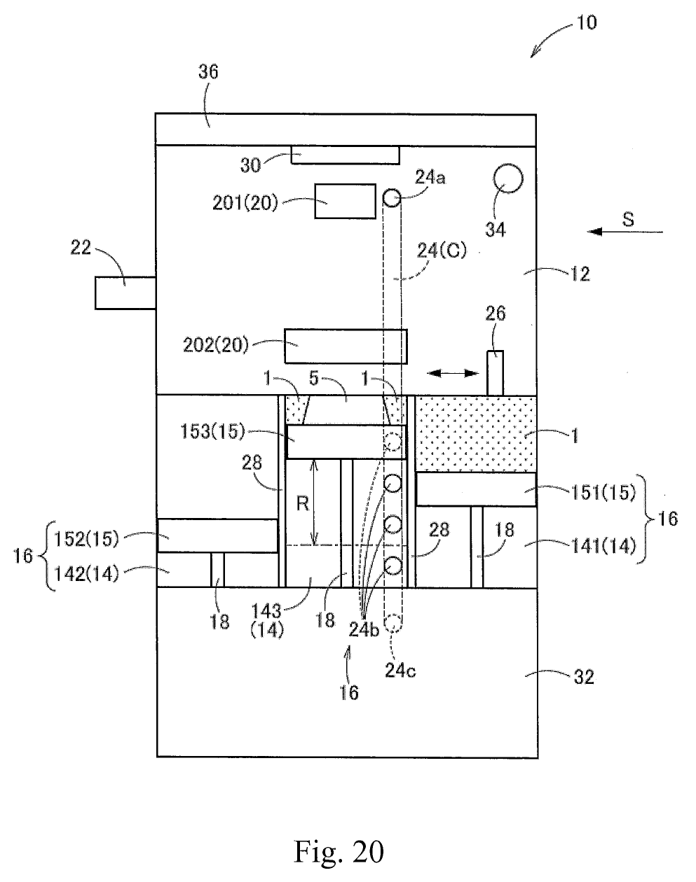

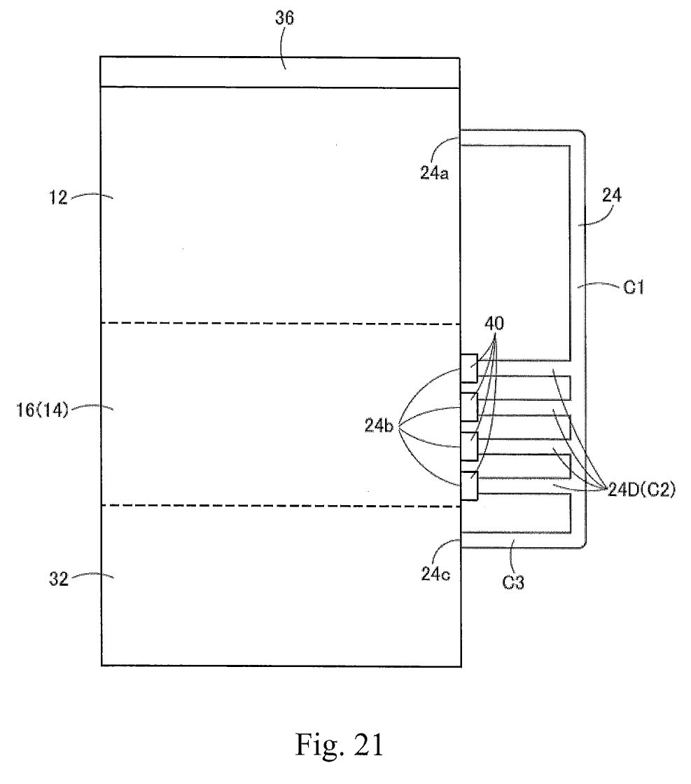

FIG. 20 shows a three-dimensional modeling apparatus 10 according to a twelfth mode. FIG. 21 shows the three-dimensional modeling apparatus 10 of FIG. 20 as viewed from a side thereof (see the arrow S in FIG. 20).

In the three-dimensional modeling apparatus 10 according to this mode, the same or similar elements as in the three-dimensional modeling apparatus 10 according to the third mode described above (see FIGS. 5 and 6) will be denoted by the same reference numerals and detailed descriptions thereof will be omitted.

The communication pipe 24 in this mode may also include a process chamber communication channel C1 that communicates with the process chamber 12 via the process chamber opening 24a, elevation guide chamber communication channels C2 that branch from the process chamber communication channel C1 and communicate with the elevation guide chambers 14 (the building elevation guide chamber 143 in this example) via the elevation chamber opening 24b, and a drive chamber communication channel C3 that branches from the process chamber communication channel C1 and communicates with the drive chamber 32 via the drive chamber opening 24c. In this mode, a plurality of elevation guide chamber communication channels C2 may be provided along the elevation direction of the elevation stage 15 (the building elevation stage 153) (that is, the vertical direction). More specifically, the communication pipe 24 may have a plurality of branch pipes 24D, and the plurality of branch pipes 24D may respectively connect to a plurality of elevation chamber openings 24b (connection openings) disposed in the wall portion of the elevation guide chamber 14 (the building elevation guide chamber 143) at different positions with respect to the vertical direction.

Each of the plurality of branch pipes 24D may be provided with a channel adjusting unit 40 (a valve portion) that adjust the operation of opening/closing the associated elevation guide chamber communication channel C2. The channel adjusting units 40 may include any device such as an electromagnetic valve and can adjust the degree of opening of the associated channel (the channel area) either stepwise or steplessly. The channel adjusting units 40 may adjust the degree of opening of the associated channel at least between the closed state where the elevation guide chamber communication channel C2 is completely closed to block the gas flow and the open state where the elevation guide chamber communication channel C2 is opened to allow the gas flow.

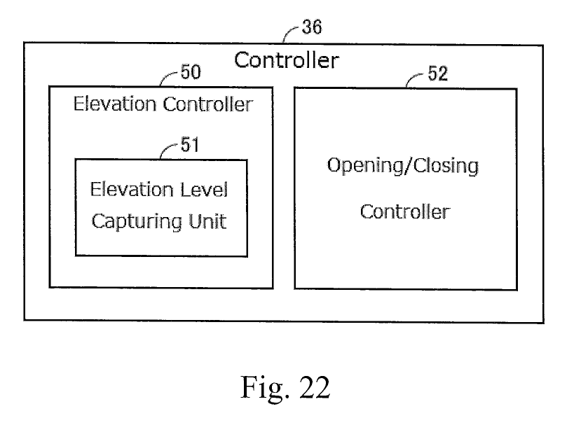

FIG. 22 is a block diagram showing an example of functionality of a controller 36 according to the twelfth mode. The controller 36 according to this mode may include an elevation controller 50 and an opening/closing controller 52 (an opening/closing control unit), and the elevation controller 50 may include an elevation level capturing unit 51.

The elevation controller 50 may control the elevation drive units 18 to adjust the elevation of the elevation stages 15 (the dispenser elevation stage 151, the collection elevation stage 152, and the building elevation stage 153). The elevation level capturing unit 51 may capture elevation data indicating the elevation levels of the elevation stages 15. The opening/closing controller 52 may control the operation of opening/closing the channel adjusting units 40 provided on the plurality of branch pipes 24D, based on the elevation data captured by the elevation level capturing unit 51. In this mode, the operation of opening/closing the channel adjusting units 40 may be controlled based on the elevation level of the building elevation stage 153.

More specifically, the opening/closing controller 52 may control the channel adjusting units 40 provided on the plurality of branch pipes 24D so as to close the elevation guide chamber communication channels C2 of the branch pipes 24D that are connected to the elevation chamber openings 24b provided in the space above the building elevation stage 153 in the building elevation guide chamber 143. For example, in FIGS. 20 and 21, when the building elevation stage 153 is at the uppermost level thereof, and all the branch pipes 24D are opened to the space below the building elevation stage 153 in the building elevation guide chamber 143, all the channel adjusting units 40 may be opened. Conversely, when the building elevation stage 153 is lowered and at least one of the plurality of branch pipes 24D is opened to the space above the building elevation stage 153 in the building elevation guide chamber 143, the channel adjusting units 40 may be closed such that the elevation guide chamber communication channels C2 of the branch pipes 24D opened to the space above the building elevation stage 153 are closed. At least part of the channel adjusting units 40 provided on the branch pipes 24D that are opened to the space below the building elevation stage 153 in the building elevation guide chamber 143 may be opened, and the gases such as the inert gas and the oxygen gas can flow through the elevation guide chamber communication channels C2 of the branch pipes 24D associated with the opened channel adjusting units 40.

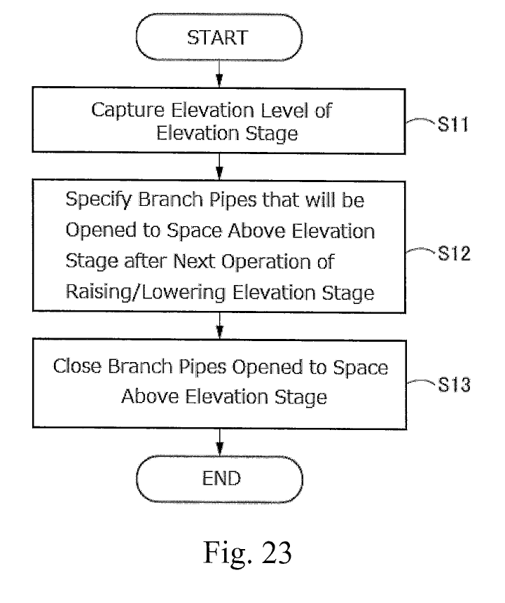

FIG. 23 is a flowchart showing an example of operation of opening/closing a channel adjusting unit 40 performed by the controller 36 according to the twelfth mode.

First, the elevation level capturing unit 51 may capture the data indicating the elevation level of the elevation stage 15 (the building elevation stage 153 in this example) with respect to the vertical direction (S11 in FIG. 23). The elevation level capturing unit 51 may send to the opening/closing controller 52 the data indicating the elevation level of the elevation stage 15 (the building elevation stage 153).

The opening/closing controller 52 may specify the branch pipes 24D that will be opened to the space above the elevation stage 15 (the building elevation stage 153) after the next operation of raising/lowering the elevation stage 15 (the building elevation stage 153), based on the data sent from the elevation level capturing unit 51 (S12). Then, the opening/closing controller 52 may control and close the channel adjusting units 40 provided on and associated with the specified branch pipes 24D, so as to close the elevation guide chamber communication channels C2 of the branch pipes 24D opened to the space above the elevation stage 15 (the building elevation stage 153) (S13). The specific timing to close the elevation guide chamber communication channels C2 of the branch pipes 24D via the channel adjusting units 40 may be at least prior to the timing when the elevation chamber openings 24b of the branch pipes 24D are positioned above the elevation stage 15 (the building elevation stage 153).

When the above sequential process is performed as the elevation stage 15 (the building elevation stage 153) is lowered, the branch pipes 24D opened to the space above the elevation stage 15 (the building elevation stage 153) may be closed to block the gas and the powder material 1, irrespective of the elevation level of the elevation stage 15 (the building elevation stage 153).

In other respects, the three-dimensional modeling apparatus 10 according to this mode may be the same as that of the third mode described above.

In this mode, the powder material 1 placed on the building elevation stage 153 may be prevented from entering the communication pipe 24 (particularly the branch pipes 24D), and the oxygen gas accumulating in the space below the building elevation stage 153 can be discharged efficiently. Also, the powder material 1 placed on the building elevation stage 153 may be prevented from being disturbed by the inert gas blown from the branch pipes 24D via the elevation chamber openings 24b.

The positions of the branch pipes 24D with respect to the vertical direction may not be particularly limited, but when the building elevation stage 153 is at the uppermost level thereof, all the branch pipes 24D may preferably be opened to the space below the building elevation stage 153 in the building elevation guide chamber 143. Further, the branch pipe 24D at the lowest position in the vertical direction (hereinafter also referred to as “the lowest branch pipe 24D”) among the plurality of branch pipes 24D may preferably be opened to the space below the movement range R of the building elevation stage 153 in the building elevation guide chamber 143. In this arrangement, at least the lowest branch pipe 24D may be opened to the space below the building elevation stage 153 in the building elevation guide chamber 143, irrespective of the elevation level of the building elevation stage 153. Therefore, the oxygen gas accumulating in the building elevation guide chamber 143 can be guided to the process chamber 12 via the lowest branch pipe 24D. In this arrangement, the lowest branch pipe 24D may not be provided with the channel adjusting unit 40, and the elevation guide chamber communication channel C2 formed by the lowest branch pipe 24D may be constantly open and allow the inflow and outflow of the gases therethrough.

When a plurality of branch pipes 24D are opened to the space below the building elevation stage 153 in the building elevation guide chamber 143, it may be possible to open only a part of the plurality of branch pipes 24D opened to the space below the building elevation stage 153 and close the other branch pipes 24D. For example, the opening/closing controller 52 may control the channel adjusting units 40 provided on the plurality of branch pipes 24D such that when two or more branch pipes 24D are opened to the space below the elevation stage 15 (the building elevation stage 153) in the elevation guide chamber 14 (the building elevation guide chamber 143), the elevation guide chamber communication channels C2 of a predetermined number of branch pipes 24D positioned relatively above among the two or more branch pipes 24D may be opened, and the channels of the other branch pipes 24D among the two or more branch pipes 24D may be closed. Thus, for example, when an inert gas having a larger specific weight than oxygen, such as argon, is used, it may be possible to efficiently discharge the oxygen gas accumulating in the building elevation guide chamber 143 and fill the inert gas into the building elevation guide chamber 143.

### <Thirteenth Mode>

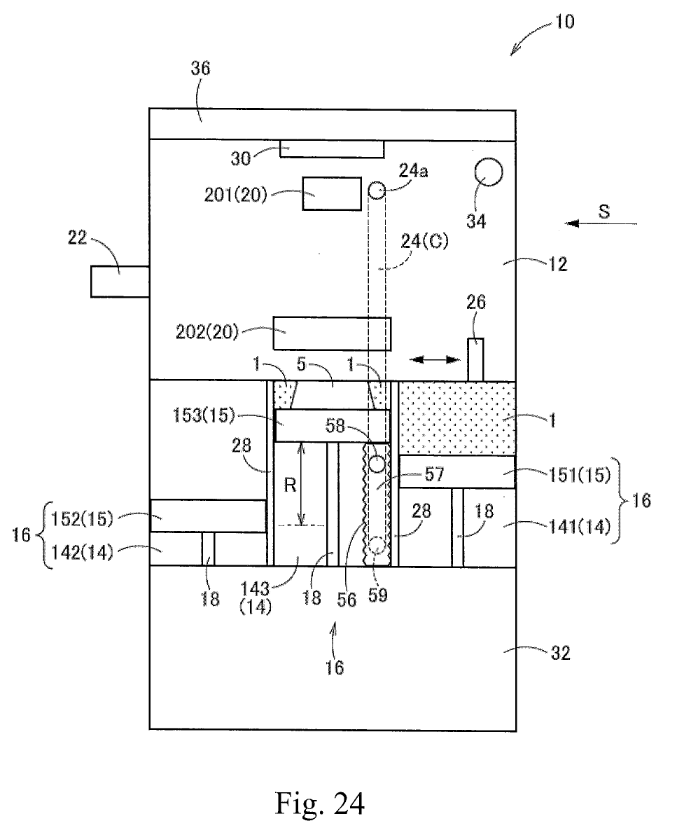

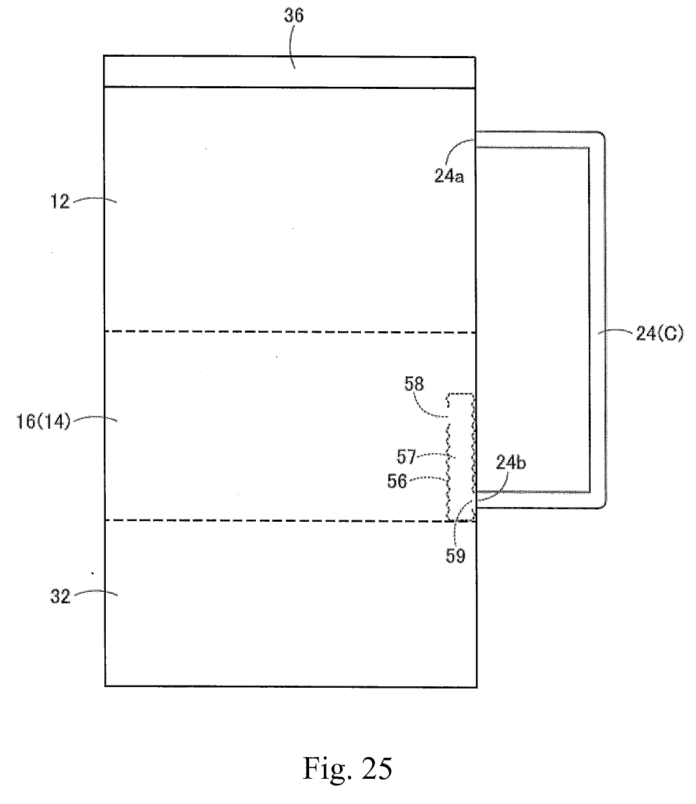

FIG. 24 shows a three-dimensional modeling apparatus 10 according to a thirteenth mode. FIG. 25 shows the three-dimensional modeling apparatus 10 of FIG. 24 as viewed from a side thereof (see the arrow S in FIG. 24).

In the three-dimensional modeling apparatus 10 according to this mode, the same or similar elements as in the three-dimensional modeling apparatus 10 according to the first mode described above (see FIGS. 1 and 2) will be denoted by the same reference numerals and detailed descriptions thereof will be omitted.

In this mode, an elastic member 56 may be provided below the elevation stage 15 (the building elevation stage 153 in this example) in the elevation guide chamber 14 (the building elevation guide chamber 143). The elastic member 56 may be attached to the elevation stage 15 (the building elevation stage 153), and may be contracted and expanded in accordance with the elevation level of the elevation stage 15 (the building elevation stage 153). The elastic member 56 may typically be constituted by a bellow member or a flexible member having a high elasticity such as those made of rubber or resins, but may alternatively be made of other members.

The elastic member 56 may include a hollow portion 57 formed therein, a first open communication portion 58 that communicates between the hollow portion 57 and the elevation guide chamber 14 (the building elevation guide chamber 143), and a second open communication portion 59 that communicates between the hollow portion 57 and the communication pipe 24. The first open communication portion 58 in this example may be provided in a side wall portion of the elastic member 56 and above the second open communication portion 59.

The first open communication portion 58 may preferably be provided closer to the elevation stage 15 (the building elevation stage 153) than may be the second open communication portion 59 (particularly immediately below the building elevation stage 153). The second open communication portion 59 in this example may be provided in a side wall of the elastic member 56 and may connect directly to the elevation chamber opening 24b of the communication pipe 24. Therefore, the channel formed by the communication pipe 24 and the hollow portion 57 in the elastic member 56 may communicate with each other via the elevation chamber opening 24b and the second open communication portion 59.

In other respects, the three-dimensional modeling apparatus 10 according to this mode may be the same as that of the first mode described above.

In this mode, the gases may flow in or out between the process chamber 12 and the elevation guide chamber 14 (the building elevation guide chamber 143) via the communication pipe 24 and the elastic member 56. Therefore, it may be possible to fill the elevation guide chamber 14 (the building elevation guide chamber 143) with the inert gas and efficiently discharge the oxygen gas accumulating in the elevation guide chamber 14 (the building elevation guide chamber 143).

In particular, the first open communication portion 58 may be constantly positioned close to the elevation stage 15 (the building elevation stage 153) irrespective of the elevation level of the elevation stage 15 (the building elevation stage 153). Accordingly, for example, when an inert gas having a larger specific weight than oxygen, such as argon, is used, it may be possible to efficiently discharge, via the first open communication portion 58 and the hollow portion 57, the oxygen gas accumulating in a relatively high region within the space below the elevation stage 15 (the building elevation stage 153) in the elevation guide chamber 14 (the building elevation guide chamber 143).

### <Fourteenth Mode>

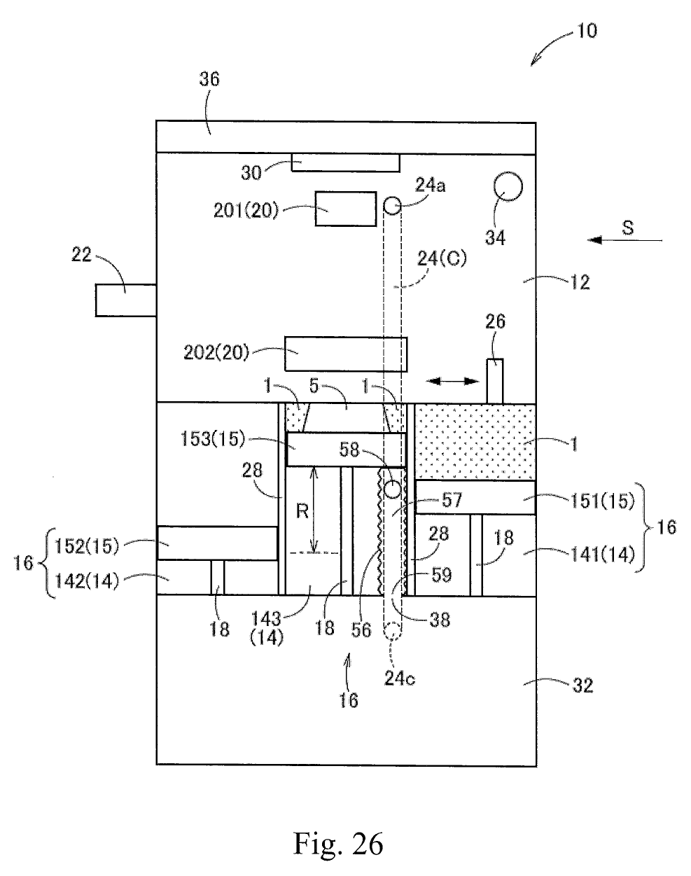

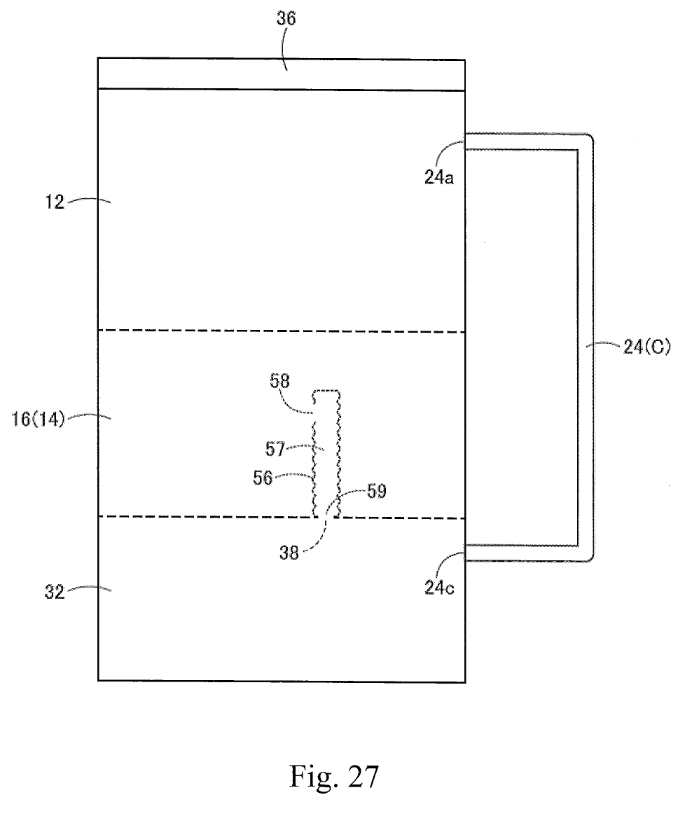

FIG. 26 shows a three-dimensional modeling apparatus 10 according to a fourteenth mode. FIG. 27 shows the three-dimensional modeling apparatus 10 of FIG. 26 as viewed from a side thereof (see the arrow S in FIG. 26).

In the three-dimensional modeling apparatus 10 according to this mode, the same or similar elements as in the three-dimensional modeling apparatus 10 according to the thirteenth mode described above (see FIGS. 24 and 25) will be denoted by the same reference numerals and detailed descriptions thereof will be omitted.

The communication pipe 24 in this mode may be opened to the process chamber 12 and the drive chamber 32, and communicate with the process chamber 12 and the drive chamber 32. A communication aperture 38 may be provided in the wall portion between the elevation guide chamber 14 (the building elevation guide chamber 143 in this example) and the drive chamber 32 so as to communicate between the elevation guide chamber 14 (the building elevation guide chamber 143) and the drive chamber 32. The second open communication portion 59 may be provided between the hollow portion 57 and the communication aperture 38 so as to communicate between the hollow portion 57 of the elastic member 56 and the communication aperture 38.

In other respects, the three-dimensional modeling apparatus 10 according to this mode may be the same as that of the thirteenth mode described above.

In this mode, the communication pipe 24, the drive chamber 32, the communication aperture 38, and the elastic member 56 may constitute the gas channel C that communicate between the process chamber 12 and the elevation guide chamber 14 (the building elevation guide chamber 143).

Therefore, in addition to the oxygen gas accumulating in the elevation guide chambers 14 (the building elevation guide chamber 143), the oxygen gas accumulating in the drive chamber 32 can be guided to the process chamber 12 and discharged out of the three-dimensional modeling apparatus 10 through the gas discharge unit 22.

### <Fifteenth Mode>

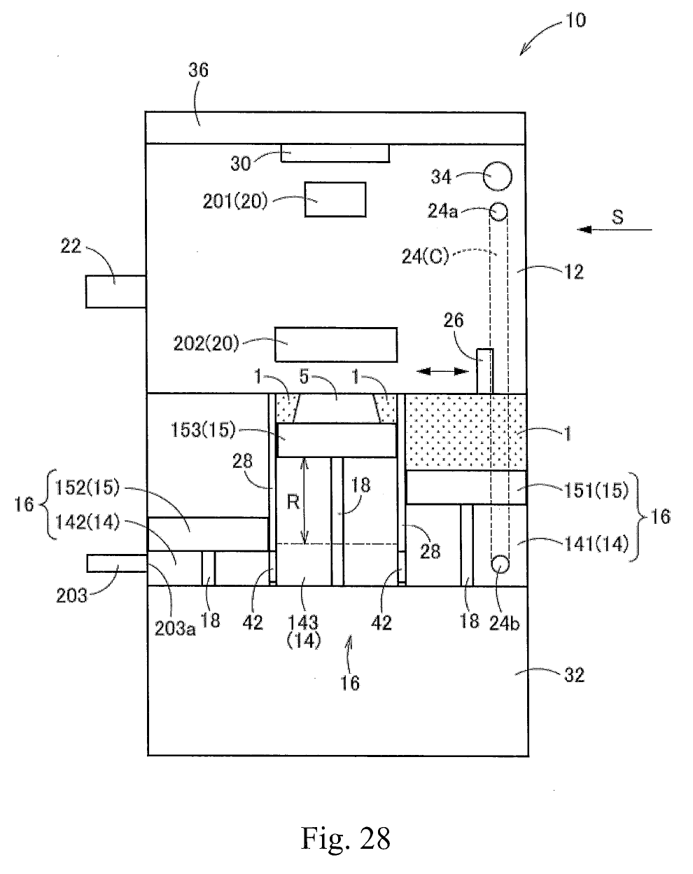

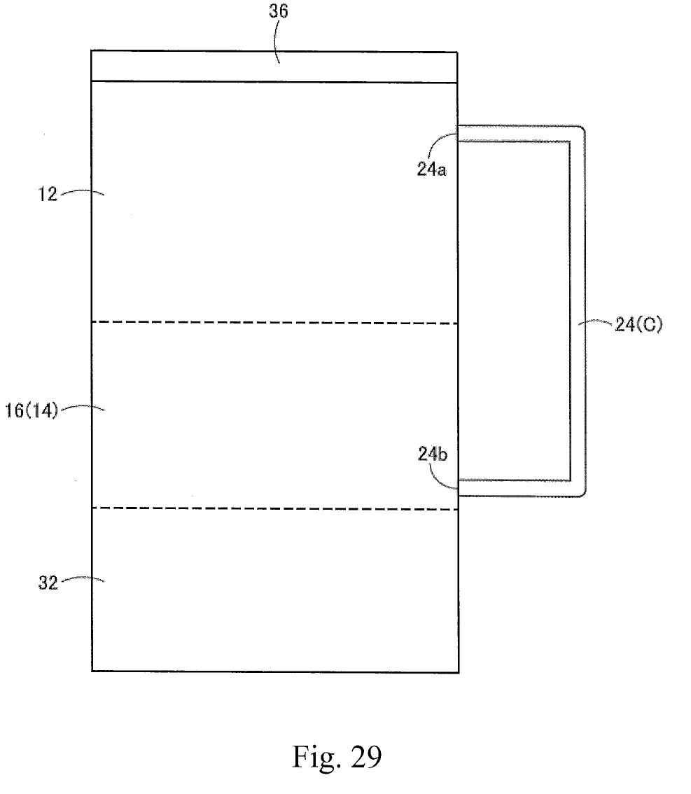

FIG. 28 shows a three-dimensional modeling apparatus 10 according to a fifteenth mode. FIG. 29 shows the three-dimensional modeling apparatus 10 of FIG. 28 as viewed from a side thereof (see the arrow S in FIG. 28).

In the three-dimensional modeling apparatus 10 according to this mode, the same or similar elements as in the three-dimensional modeling apparatus 10 according to the eighth mode described above (see FIG. 15) will be denoted by the same reference numerals and detailed descriptions thereof will be omitted.

The gas supply unit 20 in this mode may include a second gas supply unit for supplying the inert gas into the elevation guide chamber 14, in addition to the first gas supply unit (the first blow unit 201 and the second blow unit 202). In the example shown in FIGS. 28 and 29, a third blow unit 203 serving as the second gas supply unit may be opened to the collection elevation guide chamber 142 provided in one end of the plurality of elevation guide chambers 14 arranged adjacent to each other. The communication pipe 24 may communicate between the dispenser elevation guide chamber 141 provided in the other end of the plurality of elevation guide chambers 14 arranged adjacent to each other and the process chamber 12.

Therefore, the third blow unit 203 may be provided on the wall portion that forms the collection elevation guide chamber 142, and the communication pipe 24 may be provided on the wall portion that forms the dispenser elevation guide chamber 141. The wall portion on which the third blow unit 203 is formed and the wall portion on which the communication pipe 24 is formed may not be opposed to each other. That is, these wall portions may not be in parallel with each other. In the example shown in FIGS. 28 and 29, the direction of the wall portion on which the third blow unit 203 is formed and the direction of the wall portion on which the communication pipe 24 is formed may be perpendicular to each other, and the direction of opening of a gas supply aperture 203a of the third blow unit 203 that blows the inert gas toward the collection elevation guide chamber 142 and the direction of opening of the elevation chamber opening 24b of the communication pipe 24 may be perpendicular to each other.

As described above, in this mode, the elevation chamber opening 24b of the communication pipe 24 that is opened to the dispenser elevation guide chamber 141 may not be in the line extending from the gas supply aperture 203a of the third blow unit 203 in the direction of the blow of the inert gas from the gas supply aperture 203a. That is, the elevation chamber opening 24b may be off the line extending in the direction of the blow of the inert gas from the gas supply aperture 203a.

In other respects, the three-dimensional modeling apparatus 10 according to this mode may be the same as that of the eighth mode described above.

In this mode, the inert gas may be supplied directly from the third blow unit 203 to the elevation guide chamber 14 (the collection elevation guide chamber 142). Thus, it may be possible to fill the elevation guide chamber 14 with the inert gas and discharge the oxygen gas from the elevation guide chamber 14 more efficiently. In particular, when the inert gas is blown from the third blow unit 203 at a high pressure and supplied directly into the elevation guide chamber 14 (the collection elevation guide chamber 142), it may be possible to diffuse the inert gas swiftly and prevent the oxygen gas from accumulating in the elevation guide chamber 14 (the collection elevation guide chamber 142) efficiently. In addition, the elevation guide chambers 14 adjacent to each other may communicate with each other via the communication holes 42. Therefore, the inert gas supplied into one elevation guide chamber 14 (the collection elevation guide chamber 142) can be efficiently delivered to all the elevation guide chambers 14 (the dispenser elevation guide chamber 141, the building elevation guide chamber 143, and the collection elevation guide chamber 142) to discharge the oxygen gas quickly.

Of the two elevation guide chambers 14 that may be positioned in both ends of the array of the elevation guide chambers 14, that is, the dispenser elevation guide chamber 141 and the collection elevation guide chamber 142, one (the collection elevation guide chamber 142 in this example) may be provided with the third blow unit 203, and the other (the dispenser elevation guide chamber 141 in this example) may be provided with the communication pipe 24. In this arrangement, the inert gas can be delivered smoothly to all the elevation guide chambers 14, and the oxygen gas can be efficiently discharged from the elevation guide chamber 14 positioned in the middle (the building elevation guide chamber 143 in this example), in addition to the elevation guide chambers 14 positioned in the both ends.

In this mode, the communication pipe 24 may communicate between the elevation guide chamber 14 (the dispenser elevation guide chamber 141) and the process chamber 12, and the gases may be discharged exclusively via the gas discharge unit 22 provided on the process chamber 12. The gases in the elevation guide chambers 14 may be guided to the process chamber 12 via the communication pipe 24. Accordingly, the oxygen density in the spaces below the elevation stages 15 of the elevation guide chambers 14 can be observed indirectly by the oxygen sensor 34 provided in the process chamber 12, and therefore, there is no need of providing an oxygen sensor in the spaces below the elevation stages 15.

The cross-sectional area of the elevation chamber opening 24b of the communication pipe 24 that is opened to the dispenser elevation guide chamber 141 and the cross-sectional area of the gas supply aperture 203a of the third blow unit 203 that blows the inert gas into the collection elevation guide chamber 142 may not be particularly limited. For example, the cross-sectional area of the elevation chamber opening 24b may be larger than that of the gas supply opening 203a. In this arrangement, the oxygen gas accumulating in the elevation guide chambers 14 (the dispenser elevation guide chamber 141, the collection elevation guide chamber 142, and the building elevation guide chamber 143) can be efficiently delivered to the process chamber 12 via the elevation chamber opening 24b and the communication pipe 24 and discharged from the gas discharge unit 22.

### <Sixteenth Mode>

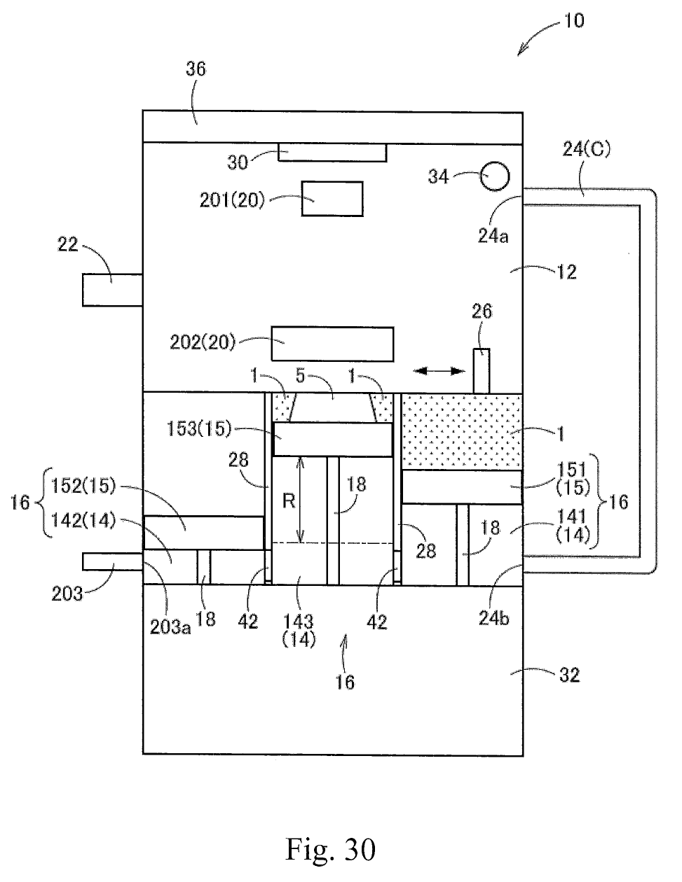

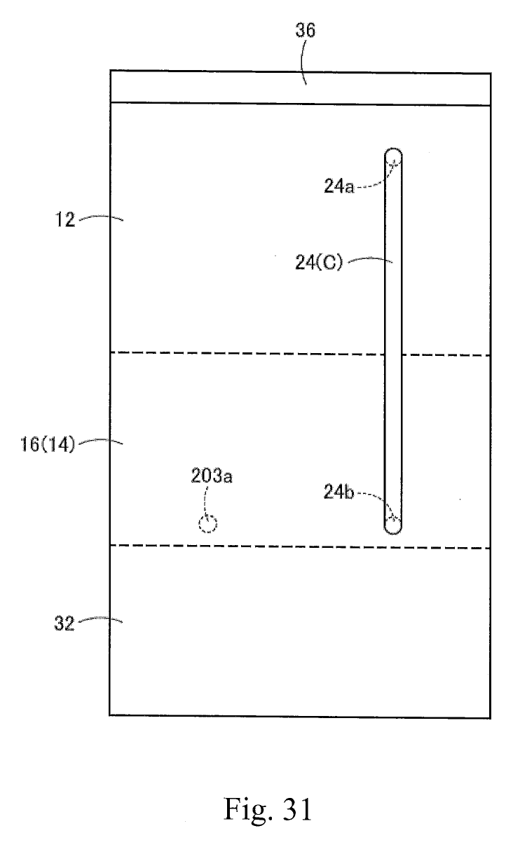

FIG. 30 shows a three-dimensional modeling apparatus 10 according to a sixteenth mode. FIG. 31 shows the three-dimensional modeling apparatus 10 of FIG. 30 as viewed from a side thereof (see the arrow S in FIG. 30).

In the three-dimensional modeling apparatus 10 according to this mode, the same or similar elements as in the three-dimensional modeling apparatus 10 according to the fifteenth mode described above (see FIGS. 28 and 29) will be denoted by the same reference numerals and detailed descriptions thereof will be omitted.

In this mode, the wall portion of the collection elevation guide chamber 142 on which the third blow unit 203 is formed and the wall portion of the dispenser elevation guide chamber 141 on which the communication pipe 24 is formed may be opposed to each other. That is, the gas supply aperture 203a of the third blow unit 203 and the elevation chamber opening 24b of the communication pipe 24 may be respectively provided on the wall portions opposed to each other.

In this mode, the gas supply aperture 203a of the third blow unit 203 and the elevation chamber opening 24b of the communication pipe 24 may be offset from each other.

More specifically, the elevation chamber opening 24b of the communication pipe 24 may not be in the line extending from the gas supply aperture 203a of the third blow unit 203 in the direction of the blow of the inert gas from the gas supply aperture 203a, but may be offset from this line in the elevation guide chamber 14 (the dispenser elevation guide chamber 141). The projection of the gas supply aperture 203a with respect to the direction of the gas supply aperture 203a (the direction of the blow of the inert gas) may be offset and separated from the projection of the elevation chamber opening 24b with respect to the direction of the gas supply aperture 203a (the direction of the blow of the inert gas). The directions in which the gas supply aperture 203a and the elevation chamber opening 24b are offset may not be particularly limited. In the example shown in FIGS. 30 and 31, the gas supply aperture 203a and the elevation chamber opening 24b may be offset from each other in a horizontal direction that is perpendicular to the vertical direction.

In other respects, the three-dimensional modeling apparatus 10 according to this mode may be the same as that of the fifteenth mode described above.

In this mode, the inert gas supplied from the gas supply aperture 203a of the third blow unit 203 can be effectively prevented from being delivered to the process chamber 12 via the elevation chamber opening 24b of the communication pipe 24 before the inert gas spreads throughout the plurality of elevation guide chambers 14 (the dispenser elevation guide chamber 141, the building elevation guide chamber 143, and the collection elevation guide chamber 142). Therefore, it may be possible to efficiently fill the plurality of elevation guide chambers 14 (the dispenser elevation guide chamber 141, the building elevation guide chamber 143, and the collection elevation guide chamber 142) with the inert gas and efficiently discharge the oxygen gas accumulating in the plurality of elevation guide chambers 14.

### <Seventeenth Mode>

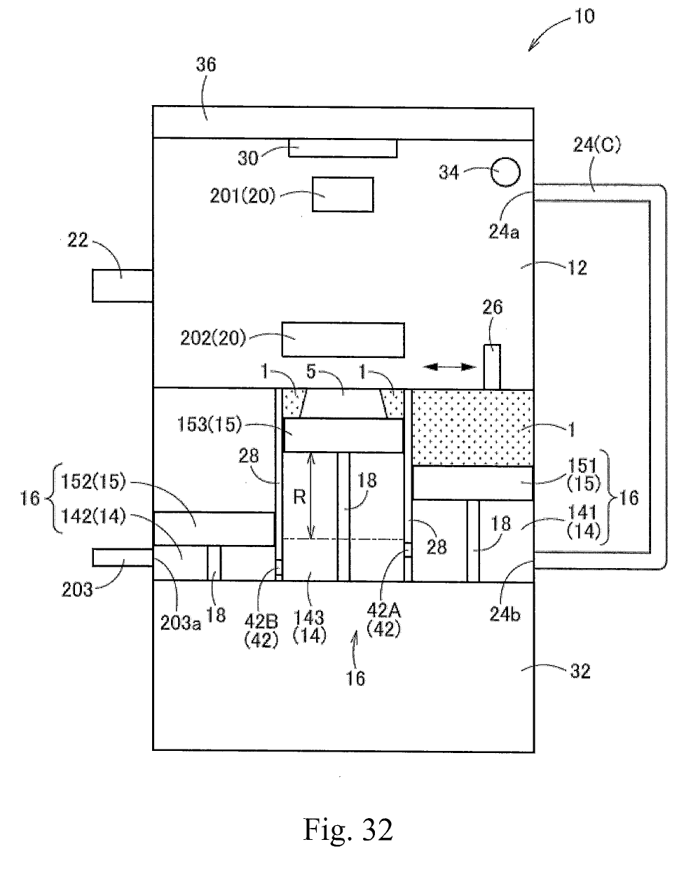

FIG. 32 shows a three-dimensional modeling apparatus 10 according to a seventeenth mode.

In the three-dimensional modeling apparatus 10 according to this mode, the same or similar elements as in the three-dimensional modeling apparatus 10 according to the sixteenth mode described above (see FIGS. 30 and 31) will be denoted by the same reference numerals and detailed descriptions thereof will be omitted.

In this mode, the first communication hole 42A provided between the dispenser elevation guide chamber 141 and the building elevation guide chamber 143 and the second communication hole 42B provided between the collection elevation guide chamber 142 and the building elevation guide chamber 143 may be offset from each other. More specifically, the line extending from the first communication hole 42A in the direction in which the first communication hole 42A faces (the direction of opening) may be misaligned with the line extending from the second communication hole 42B in the direction in which the second communication hole 42B faces (the direction of opening). Therefore, the projection of the first communication hole 42A with respect to the direction of opening of the first communication hole 42A (the left-right direction in FIG. 32) may be separated from the projection of the second communication hole 42B with respect to the same direction. The directions in which the first communication hole 42A and the second communication hole 42B are offset may not be particularly limited. In the example shown in FIG. 32, the first communication hole 24A and the second communication hole 42B may be offset from each other in the vertical direction.

In this mode, the gas supply aperture 203a and the elevation chamber opening 24b may be respectively provided in the wall portions opposed to each other, and the gas supply aperture 203a may be provided in the line extending from the elevation chamber opening 24b in the direction in which the elevation chamber opening 24b faces. In this mode, the plurality of communication holes (the first communication hole 42A and the second communication hole 42B) may include a communication hole (the first communication hole 42A in the example shown in FIG. 32) that is separated from the line connecting the gas supply aperture 203a of the third blow unit 203 that blows the inert gas into the collection election guide chamber 142 with the elevation chamber opening 24b of the communication pipe 24 that is opened to the dispenser elevation guide chamber 141.

In other respects, the three-dimensional modeling apparatus 10 according to this mode may be the same as that of the sixteenth mode described above.

In this mode, the inert gas supplied from the gas supply aperture 203a of the third blow unit 203 can be effectively prevented from being delivered to the process chamber 12 via the elevation chamber opening 24b of the communication pipe 24 before the inert gas spreads throughout the plurality of elevation guide chambers 14 (the dispenser elevation guide chamber 141, the building elevation guide chamber 143, and the collection elevation guide chamber 142).

### <Variations>

The present invention is not limited to the modes and variations described above and is susceptible of various modification. Also, any parts or the entirety of the above modes and variations may be combined with each other.

For example, in the above modes, three elevation units 16 (the dispenser unit, the building unit, and the collection unit) may be provided. Alternatively, the three-dimensional modeling apparatus 10 may include only one or two elevation units 16 or include four or more elevation units 16. Accordingly, in the three-dimensional modeling apparatus 10, for example, the collection elevation guide chamber 142 may not contain the collection elevation stage 152 of the collection unit.

The positions of the communication pipe 24 and the third blow unit 203 may be modified as necessary. For example, the communication pipe 24 may be opened to other elevation guide chambers 14 (the dispenser elevation guide chamber 141 and/or the collection elevation guide chamber 142) in addition to, or instead of, the building elevation guide chamber 143. Further, the third blow unit 203 may supply the inert gas to other elevation guide chambers 14 (the dispenser elevation guide chamber 141 and/or the building elevation guide chamber 143) in addition to, or instead of, the collection elevation guide chamber 142.

In the above modes, the powder material 1 may be solidified (sintered) with a laser beam, but the means for solidifying the powder material 1 is not particularly limited. For example, the emission unit 30 may emit an electron beam, and the powder material 1 may solidify when irradiated with the electron beam emitted from the emission unit 30.

The present invention is not limited to the above modes and variations but may include various aspects modified variously as could be conceived by those skilled in the art, and the effects produced by the present invention are not limited to those described above. Accordingly, addition, modification, and partial deletion of the elements described in the specification or recited in the claims can be made within the technical idea and the purport of the present invention.

### Second Embodiment

### <First Mode>

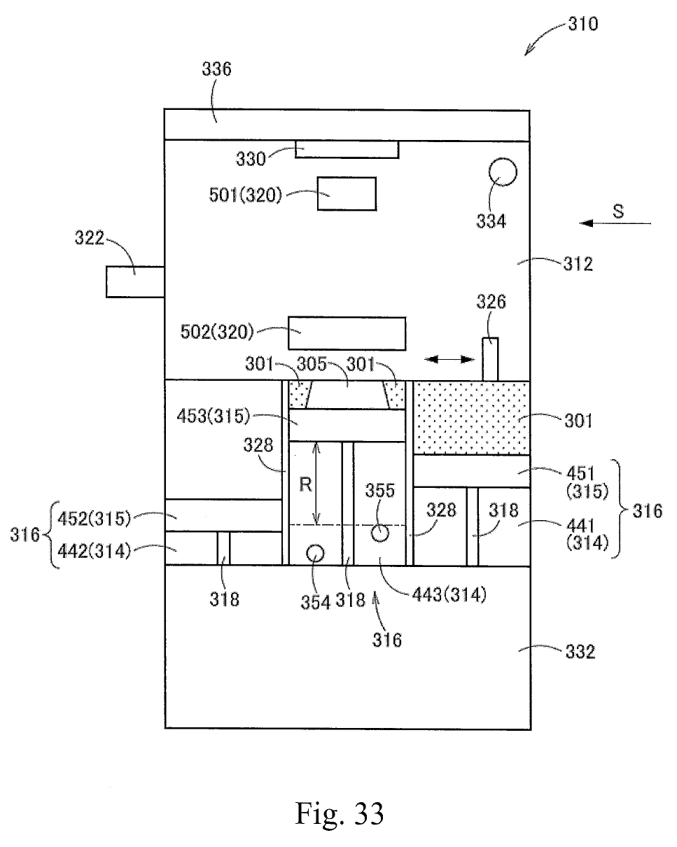

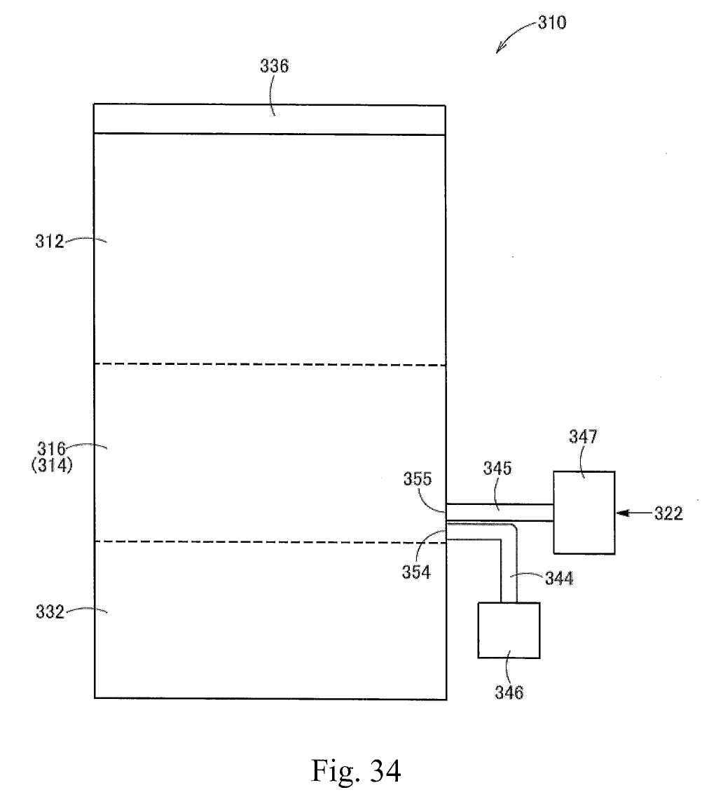

FIG. 33 shows a three-dimensional modeling apparatus 310 according to a first mode. FIG. 34 schematically shows the three-dimensional modeling apparatus 310 of FIG. 33 as viewed from a side thereof (see the arrow S in FIG. 33). In FIG. 33, a process chamber 312 and elevation units 316 are schematically illustrated with the interior thereof as viewed from a side, so as to facilitate comprehension.

The three-dimensional modeling apparatus 310 according to this mode may conduct lamination modeling of a three-dimensional object 305 by sintering (solidifying) a powder material 301 such as titanium in the air-tight process chamber 312, and may include the process chamber 312, a plurality of elevation units 316 (three elevation units 316 in this mode) provided below the process chamber 312, and a drive chamber 332 provided below the elevation units 316. The powder material 301 may be a metal powder made of titanium, iron, stainless steel, aluminum, steel, or other alloys, a synthetic powder such as polyamide or polystyrene, polyether ether ketone (PEEK), synthetic coating sand, or a ceramic powder.

Each of the elevation units 316 may include an elevation guide chamber 314 provided adjacent to the process chamber 312 and an elevation stage 15 provided so as to be capable of being raised and lowered in the elevation guide chamber 314. Each elevation stage 315 may be raised and lowered so as to slide on the surfaces of side walls that define the associated elevation guide chamber 314. In each elevation guide chamber 314, there may be provided a sealing member (not shown) between the surfaces of the side walls of the elevation guide chamber 314 and the associated elevation stage 315, and the sealing member may block a gap therebetween. The sealing member may block the powder material 301 such that the powder material 301 may not pass the gap between the elevation guide chamber 314 and the elevation stage 315. The sealing member may preferably prevent a gas such as oxygen from passing the gap between the elevation guide chamber 314 and the elevation stage 315 but may not necessarily provide strict air-tightness. Thus, each of the elevations guide chambers 314 may be partitioned by the associated elevation stage 315 into a space above the elevation stage 315 and a space below the elevation stage 315.

The three elevation units 316 may be constituted by a dispenser unit, a collection unit, and a building unit provided between the dispenser unit and the collection unit. The dispenser unit may include a dispenser elevation guide chamber 441 (a first elevation guide chamber) and a dispenser elevation stage 451, the building unit may include a building elevation guide chamber 443 (a third elevation guide chamber) and a building elevation stage 453, and the collection unit may include a collection elevation guide chamber 442 (a second elevation guide chamber) and a collection elevation stage 452. FIG. 33 shows the dispenser unit, the building unit, and the collection unit arranged in this order from right to left. There may be provided partition walls 328 between the dispenser elevation guide chamber 441 and the building elevation guide chamber 443 and between the collection elevation guide chamber 442 and the building elevation guide chamber 443. The dispenser elevation guide chamber 441, the building elevation guide chamber 443, and the collection elevation guide chamber 442 may be arranged adjacent to each other with the partition walls 328 therebetween.

Each of the elevation stages 315 (the dispenser elevation stage 451, the collection elevation stage 452, and the building elevation stage 453) may be provided with an elevation drive unit 318 configured to raise and lower the elevation stages 315. The elevation drive unit 318 may raise and lower the associated elevation stage 315 under the control by a controller 336. The dispenser elevation stage 451, the collection elevation stage 452, and the building elevation stage 453 may be raised and lowered in association with each other.

The dispenser unit (the dispenser elevation guide chamber 441 and the dispenser elevation stage 451) may provide a space for retaining the powder material 301, and the powder material 301 used for modeling the three-dimensional object 305 may be placed on the dispenser elevation stage 451. The building unit (the building elevation guide chamber 443 and the building elevation stage 453) may conduct modeling of the three-dimensional object 305. The building elevation stage 453 may serve for modeling conducted thereon. The powder material 301 placed on the building elevation stage 453 may be sintered with a laser beam emitted from an emission unit 330 to form the three-dimensional object 305. The collection unit (the collection elevation guide chamber 442 and the collection elevation stage 452) may provide a space for collecting an excess portion of the powder material 301 supplied to the building elevation guide chamber 443, and the excess portion of the powder material 301 may be accumulated on the collection elevation stage 452.

The process chamber 312 may contain an application unit 326 that can reciprocate horizontally above the dispenser elevation stage 451, the building elevation stage 453, and the collection elevation stage 452. When the application unit 326 moves horizontally, the powder material 301 may be supplied from the dispenser elevation guide chamber 441 into the building elevation guide chamber 443, and the excess portion of the powder material 301 may be pressed from above the building elevation guide chamber 443 into the collection elevation guide chamber 442. More specifically, the first step to supply a required amount of powder material 301 into the building elevation guide chamber 443 may be to raise the dispenser elevation stage 451, lower the building elevation stage 453, and lower the collection elevation stage 452. Then, the application unit 326 disposed above the dispenser elevation stage 451 may move horizontally to above the building elevation guide chamber 443 and the collection elevation guide chamber 442. Thus, the topmost portion of the powder material 301 on the dispenser elevation stage 451 may be pressed toward the building elevation guide chamber 443, and further powder material 301 may be supplied into the building elevation guide 443. The excess portion of the powder material 301 that is not contained in the building elevation guide chamber 443 may be pressed toward and contained in the collection elevation guide chamber 442.

Thus, the operation of the application unit 326 and the elevation stages 315 (the dispenser elevation stage 451, the collection elevation stage 452, and the building elevation stage 453) may be performed in cooperation with each other under the control by the controller 336, such that an adequate amount of powder material 301 can be supplied into the building elevation stage 453 to form layers. The distances by which the dispenser elevation stage 451 is raised, the building elevation stage 453 is lowered, and the collection elevation stage 452 is lowered may preferably be set such that a slightly larger amount of powder material 301 than is required to be supplied to above the building elevation stage 453 is supplied from the dispenser elevation guide chamber 441 to above the building elevation stage 453 and the excess portion of the powder material 301 that is not contained in the building elevation guide chamber 443 is contained in the collection elevation guide chamber 442. In addition, the distance by which the building elevation stage 453 is lowered may be set in accordance with the thickness of the layer of the powder material 301 to be sintered by application of a laser beam. By way of an example, it may be possible to lower the collection elevation stage 452 and the building elevation stage 453 by 0.1 mm and raise the dispenser elevation stage 451 by 0.2 mm for one stroke.

The process chamber 312 may also contain a gas supply unit 320, a gas discharge unit 322, an emission unit 330, and an oxygen sensor 334, in addition to the application unit 326.

The gas supply unit 320 in this mode may include a first gas supply unit 501, 502 for supplying an inert gas such as argon or nitrogen (particularly argon in this mode) to the process chamber 312. In the example shown in FIG. 33, the first gas supply unit 501, 502 may include a first blow unit 501 provided above the building unit (the building elevation guide chamber 443 and the building elevation stage 453) and a second blow unit 502 provided between the building unit and the first blow unit 501 (that is, below the first blow unit 501). The first blow unit 501 and the second blow unit 502 may blow an inert gas into the space above the building unit so as not to substantially impact the powder material 301 placed on the building elevation stage 453 and the three-dimensional object 305. The specific configuration and the position of the gas supply unit 320 are not particularly limited but may be set such that an inert gas can be supplied to at least one of the process chamber 312 and the elevation guide chambers 314.

The gas discharge unit 322 may communicate with the process chamber 312 and may be configured to discharge gases from the process chamber 312 out of the three-dimensional modeling apparatus 310.

The emission unit 330 according to this mode may emit a laser beam onto the powder material 301 on an elevation stage 315 (the building elevation stage 153 in this example) to solidify the powder material 301 (sinter the powder material 301 in this example). In the example shown in FIG. 33, the emission unit 330 may be installed in the process chamber 312 above the building unit (the building elevation guide chamber 443 and the building elevation stage 453). However, the position to install the emission unit 330 may not be particularly limited. The emission unit 330 may be installed in other positions within the process chamber 312 or installed outside the process chamber 312, as long as it can appropriately emit a laser beam onto the powder material 301 on the building elevation stage 453.

The oxygen sensor 334 may be installed in the process chamber 312 and may be configured to sense the oxygen density. The position to install the oxygen sensor 334, which may not be particularly limited, may preferably be set based on the relationship between the specific weights of the inert gas supplied from the gas supply unit 320 and oxygen. For example, if the specific weight of oxygen is smaller than that of the inert gas, the oxygen sensor 334 may preferably be installed in a relatively high position within the process chamber 312, and if the specific weight of oxygen is larger than that of the inert gas, the oxygen sensor 334 may preferably be installed in a relatively low position within the process chamber 312.

In the wall portion that forms the elevation guide chamber 314 (the building elevation guide chamber 443 in this example), there may be provided an inert gas supply opening 354 and a gas discharge opening 355.

The inert gas supply opening 354 and the gas discharge opening 355 may be opened to (communicate with) a space below the movement range R of the elevation stage 315 (the building elevation stage 453) in the elevation guide chamber 314 (the building elevation guide chamber 443). The inert gas supply opening 354 may communicate with a space below the associated elevation stage 315 (the building elevation stage 453 in this example) in the elevation guide chamber 314 (the building elevation guide chamber 443) and may connect with an inert gas supply pipe 344 that extends from an inert gas supply unit 346 configured to deliver the inert gas. Accordingly, the inert gas supply pipe 344 may function as the gas supply unit 320 along with the first blow unit 501 and the second blow unit 502 and serve as the second gas supply unit. The gas discharge opening 355 may communicate with a space below the elevation stage 315 (the building elevation stage 453) in the elevation guide chamber 314 (the building elevation guide chamber 443) and may connect with a gas discharge pipe 345 that extends from a gas collection unit 347 configured to collect the gases.

In this mode, the gas collection unit 347 may serve as a recycling unit for recycling the inert gas. The discharge gas may be delivered to the gas collection unit 347 from the gas discharge unit 322 as well as from the elevation guide chamber 314 (the building elevation guide chamber 443). The recycling process is not particularly limited. For example, the gas collection unit 347 may extract a desired inert gas from the collected gas or free the collected gas from gaseous, liquid, and/or solid impurities other than the inert gas contained in the collected gas.

The inert gas supply opening 354 and the gas discharge opening 355 may be positioned at different levels with respect to the vertical direction. In this example, the gas discharge opening 355 may be positioned above the inert gas supply opening 354.

The drive chamber 332 may contain at least a part of the elevation drive units 318. For example, when an elevation drive unit 318 includes a projecting portion having one end thereof fixed to an associated elevation stage 315 (the dispenser elevation stage 451, the collection elevation stage 452, or the building elevation stage 453) and capable of projecting by a varied distance, and a motor (for example, a stepping motor) for driving the projecting portion, the drive chamber 332 may contain the motor and a part of the other end of the projecting portion.

The controller 336 may be installed above the process chamber 312. The controller 336 may control the units in the three-dimensional modeling apparatus 310. For example, the controller 336 may control the elevation drive units 318 to raise or lower the elevation stages 315, control the horizontal movement of the application unit 326, control the laser beam emission of the emission unit 330, and control supply of the inert gas from the gas supply unit 320. In particular, the controller 336 in this mode may receive the sensing values from the oxygen sensor 334 and, when the oxygen sensor 334 senses an oxygen density higher than a threshold value, the controller 336 may stop the elevation operation of the elevation stages 315, the horizontal movement of the application unit 326, and the laser beam emission from the emission unit 330, suspend modeling of the three-dimensional object 305, and issue an error message to an operator visually or audibly.

As described above, in this mode, the inert gas supply unit 346 may supply the inert gas to the space below the building elevation stage 453 in the building elevation guide chamber 443 via the inert gas supply pipe 344 and the inert gas supply opening 354. The gas that contains oxygen accumulating in this space may be collected from the space into the gas collection unit 347 via the gas discharge opening 355 and the gas discharge pipe 345. Thus, it may be possible to discharge the oxygen gas accumulating in the three-dimensional modeling apparatus 310 (particularly in the building elevation guide chamber 443) out of the three-dimensional modeling apparatus 310 and effectively prevent oxidation of the material of the three-dimensional object 305 during modeling. In particular, the inert gas may be supplied directly to the space below the building elevation stage 453 in the building elevation guide chamber 443, and therefore, the inert gas can be supplied to the space at a high pressure to diffuse the inert gas effectively. Thus, the oxygen gas accumulating in the space below the building elevation stage 453 in the building elevation guide chamber 443 can be quickly discharged to the gas collection unit 347 via the gas discharge opening 355 and the inert gas supply opening 354. Additionally, the nitrogen gas may also be discharged in the argon gas environment.

The oxygen gas accumulating in the space above the building elevation stage 453 in the building elevation guide chamber 443 and the process chamber 312 may be discharged from the gas discharge unit 322 due to the effect of the inert gas supplied from the first blow unit 501 and the second blow unit 502.

The inert gas supply opening 354 and the gas discharge opening 355 may be positioned below the movement range R of the building elevation stage 453. Therefore, the oxygen gas accumulating in the building elevation guide chamber 443 (particularly the space below the building elevation stage 453) can be efficiently discharged without narrowing the movement range R of the building elevation stage 453 and irrespective of the elevation level of the building elevation stage 453. In addition to oxygen, nitrogen included in the remaining air can also be discharged in the same manner. This may also apply to other modes described below.

In the three-dimensional modeling apparatus 310 of this mode, the oxygen sensor 334 may no longer or seldom sense an oxygen density higher than a threshold value, and therefore, even in the case where modeling should be suspended when the oxygen sensor 334 senses an oxygen density higher than a threshold value, modeling may be no longer or seldom suspended unexpectedly.

The inert gas supply opening 354 and the gas discharge opening 355 may be positioned at different levels with respect to the vertical direction, and therefore, the gas flow can be smoothened in the building elevation guide chamber 443, and the supply of the inert gas and the discharge of the oxygen gas can be efficient. In particular, the gas discharge opening 355 may be positioned above the inert gas supply opening 354, such that when argon, having a larger specific weight than oxygen, is used as an inert gas, the oxygen gas may tend to be present above the inert gas and can be efficiently delivered to the gas collection unit 347 via the gas discharge opening 355 and the gas discharge pipe 345.

The gas collection unit 347 may recycle the inert gas for effective reuse of the inert gas. The inert gas recycled in the gas collection unit 347 may be returned into the three-dimensional modeling apparatus 310 (the process chamber 312 and/or the elevation guide chamber 314) or may be used for other applications.

### <Second Mode>

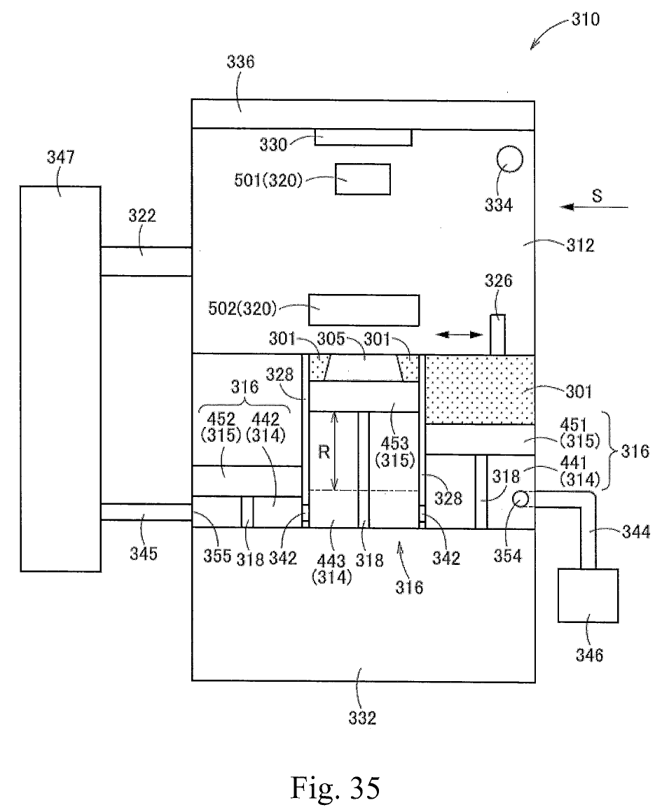

FIG. 35 shows a three-dimensional modeling apparatus 310 according to a second mode.

In the three-dimensional modeling apparatus 310 according to this mode, the same or similar elements as in the three-dimensional modeling apparatus 310 according to the first mode described above (see FIGS. 33 and 34) will be denoted by the same reference numerals and detailed descriptions thereof will be omitted.

In this mode, the inert gas supply opening 354 and the gas discharge opening 355 may be opened to at least one of the plurality of elevation guide chambers 314 (the dispenser elevation guide chamber 441, the building elevation guide chamber 443, and the collection elevation guide chamber 442) (the dispenser elevation guide chamber 441 and the collection elevation guide chamber 442 in this example). More specifically, the inert gas supply opening 354 may be opened to the dispenser elevation guide chamber 441, which may be provided in one end of the plurality of elevation guide chambers 314 arranged adjacent to each other. The gas discharge opening 355 may be opened to the collection elevation guide chamber 442, which may be provided in the other end of the plurality of elevation guide chambers 314 arranged adjacent to each other. The inert gas supply opening 354 may be opened to the space below the movement range R of the dispenser elevation stage 451 in the dispenser elevation guide chamber 441, and the gas discharge opening 355 may be opened to the space below the movement range R of the collection elevation stage 452 in the collection elevation guide chamber 442.

The wall portion that forms the dispenser elevation guide chamber 441 and includes the inert gas supply opening 354 and the wall portion that forms the collection elevation guide chamber 442 and includes the gas discharge unit 355 may not be opposed to each other. That is, these wall portions may not be in parallel with each other. More specifically, in the example shown in FIG. 35, the inert gas supply opening 354 may be provided in the wall portion facing in the direction of depth of the drawing, while the gas discharge opening 355 may be provided in the wall portion facing in the left-right direction of the drawing.

Any two elevation guide chambers 314 arranged adjacent to each other (in this example, the dispenser elevation guide chamber 441 and the building elevation guide chamber 443, or the collection elevation guide chamber 442 and the building elevation guide chamber 443) may communicate with each other via the communication hole 342. The cross-sectional areas of the openings (hereinafter also referred to as “opening cross-sectional areas”) of the communication holes 342 may not be particularly limited. All the communication holes 342 may have the same opening cross-sectional areas, or alternatively, the communication hole 342 that communicates between the dispenser elevation guide chamber 441 and the building elevation guide chamber 443 and the communication hole 342 that communicates between the collection elevation guide chamber 442 and the building elevation guide chamber 443 may have different opening cross-sectional areas. The number of communication holes 342 that communicate between the dispenser elevation guide chamber 441 and the building elevation guide chamber 443 and the number of communication holes 342 that communicate between the collection elevation guide chamber 442 and the building elevation guide chamber 443 may also not be particularly limited. Each of the partition walls 328 may include one or more communication holes 342.

In other respects, the three-dimensional modeling apparatus 310 according to this mode may be the same as that of the first mode described above.

In this mode, the inert gas supplied from the inert gas supply unit 346 to the dispenser elevation guide chamber 441 via the inert gas supply pipe 344 and the inert gas supply opening 354 may be diffused into the building elevation guide chamber 443 and the collection elevation guide chamber 442 via the communication holes 342. As the inert gas flows in, the oxygen gas accumulating in the dispenser elevation guide chamber 441 and the building elevation guide chamber 443 may be moved and delivered to the collection elevation guide chamber 442, and collected into the gas collection unit 347 via the gas discharge opening 355 and the gas discharge pipe 345. Therefore, it may be possible to discharge the oxygen gas from all the elevation guide chambers 314 (the dispenser elevation guide chamber 441, the building elevation guide chamber 443, and the collection elevation guide chamber 442) and fill all the elevation guide chambers 314 with the inert gas.

In particular, the inert gas supply opening 354 and the gas discharge opening 355 may be respectively opened to the dispenser elevation guide chamber 441 and the collection elevation guide chamber 442, which may be disposed in the opposite ends of the array of the elevation guide chambers 314. Thus, the inert gas can flow from the dispenser elevation guide chamber 441 to the collection elevation guide chamber 442, such that the inert gas may be supplied to the building elevation guide chamber 443 disposed between the dispenser elevation guide chamber 441 and the collection elevation guide chamber 442. Accordingly, the oxygen gas can be discharged from other elevation guide chambers 314 (the dispenser elevation guide chamber 441 and the building elevation guide chamber 443) as well as from the collection elevation guide chamber 442 to which the gas discharge opening 355 is opened.

The inert gas supply opening 354 and the gas discharge opening 355 may be provided in the wall portions that are not opposed to or in parallel with each other, and therefore, the inert gas supplied from the inert gas supply opening 354 may be diffused efficiently in the elevation guide chambers 314 (the dispenser elevation guide chamber 441, the building elevation guide chamber 443, and the collection elevation guide chamber 442). Thus, the oxygen gas can be prevented from accumulating in the elevation guide chambers 314 and discharged from the elevation guide chambers 314 efficiently.

### <Third Mode>

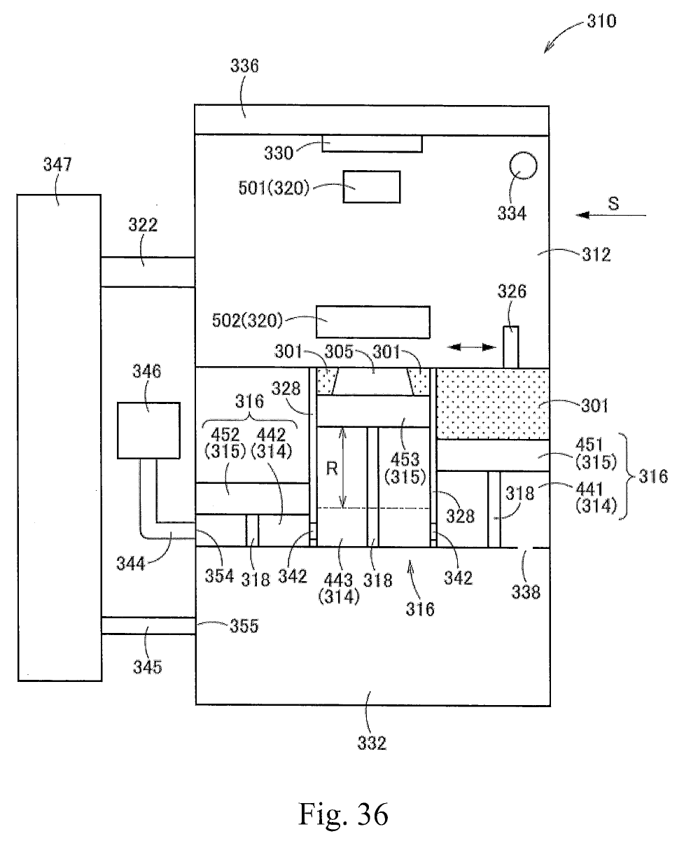

FIG. 36 shows a three-dimensional modeling apparatus 310 according to a third mode.

In the three-dimensional modeling apparatus 310 according to this mode, the same or similar elements as in the three-dimensional modeling apparatus 310 according to the first mode described above (see FIGS. 33 and 34) will be denoted by the same reference numerals and detailed descriptions thereof will be omitted.

In this mode, the inert gas supply opening 354 may be opened to the elevation guide chamber 314 (the collection elevation guide chamber 442 in this example), and the gas discharge opening 355 may be opened to the drive chamber 332.

The wall portion of the elevation guide chamber 314 (the collection elevation guide chamber 442) in which the inert gas supply opening 354 is formed and the wall portion of the drive chamber 332 in which the gas discharge opening 355 is formed may face in the same direction. That is, these wall portions may be in parallel with each other. In the example shown in FIG. 36, the inert gas supply opening 354 and the gas discharge opening 355 may be provided in the wall portions facing in the left-right direction of the drawing.

Any two elevation guide chambers 314 arranged adjacent to each other (in this example, the dispenser elevation guide chamber 441 and the building elevation guide chamber 443, or the collection elevation guide chamber 442 and the building elevation guide chamber 443) may communicate with each other via the communication hole 342. The opening cross-sectional areas of the communication holes 342 may not be particularly limited. All the communication holes 342 may have the same opening cross-sectional areas, or alternatively, the communication hole 342 that communicates between the dispenser elevation guide chamber 441 and the building elevation guide chamber 443 and the communication hole 342 that communicates between the collection elevation guide chamber 442 and the building elevation guide chamber 443 may have different opening cross-sectional areas. The number of communication holes 342 that communicate between the dispenser elevation guide chamber 441 and the building elevation guide chamber 443 and the number of communication holes 342 that communicate between the collection elevation guide chamber 442 and the building elevation guide chamber 443 may also not be particularly limited. Each of the partition walls 328 may include one or more communication holes 342.

The drive chamber 332 may communicate with at least one of the plurality of elevation guide chambers 314 (the dispenser elevation guide chamber 441 in this example) via the communication apertures 338. That is, one or more communication apertures 338 that allow gas flow may be provided in the wall portion partitioning the dispenser elevation guide chamber 441 from the drive chamber 332. The opening cross-sectional areas of the communication apertures 338 are not particularly limited. When a plurality of communication apertures 338 are provided, these communication apertures 338 may have either the same or different opening cross-sectional areas. Thus, in this three-dimensional modeling apparatus 310, the communication apertures 338 may be opened to the dispenser elevation guide chamber 441 in one end of the array of the elevation guide chambers 314, and the inert gas supply opening 354 may be opened to the collection elevation guide chamber 442 in the other end.

In other respects, the three-dimensional modeling apparatus 310 according to this mode may be the same as that of the first mode described above.

In this mode, the inert gas may be supplied directly to the elevation guide chamber 314 (the collection elevation guide chamber 442 in this example). Thus, it may be possible to fill the elevation guide chamber 314 with the inert gas and discharge the oxygen gas from the elevation guide chamber 314 quickly. In this mode, the inert gas supplied to the collection elevation guide chamber 442 via the inert gas supply opening 354 may be discharged from the gas discharge opening 355 via the building elevation guide chamber 443, the dispenser elevation guide chamber 441, and the drive chamber 332. Accordingly, it may be possible to discharge the oxygen gas accumulating in all the elevation guide chambers 314 and the drive chamber 332 and make sure that the oxygen gas is prevented from accumulating in the three-dimensional modeling apparatus 310.

The inert gas supply opening 354 may be opened to at least one of the plurality of elevation guide chambers 314. The inert gas supply opening 354 may be opened to an elevation guide chamber 314 other than the collection elevation guide chamber 442, or may be opened to two or three elevation guide chambers 314.

The communication apertures 338 may communicate between any one of the plurality of elevation guide chambers 314 and the drive chamber 332 and may not necessarily communicate between the dispenser elevation guide chamber 441 and the drive chamber 332. The plurality of communication apertures 338 may be provided so as to communicate between a plurality of elevation guide chambers 314 and the drive chamber 332. Accordingly, the communication apertures 338 may be provided in any one or more wall portions among the wall portion that partitions the dispenser elevation guide chamber 441 from the drive chamber 332, the wall portion that partitions the building elevation guide chamber 443 from the drive chamber 332, and the wall portion that partitions the collection elevation guide chamber 442 from the drive chamber 332.

### <Fourth Mode>

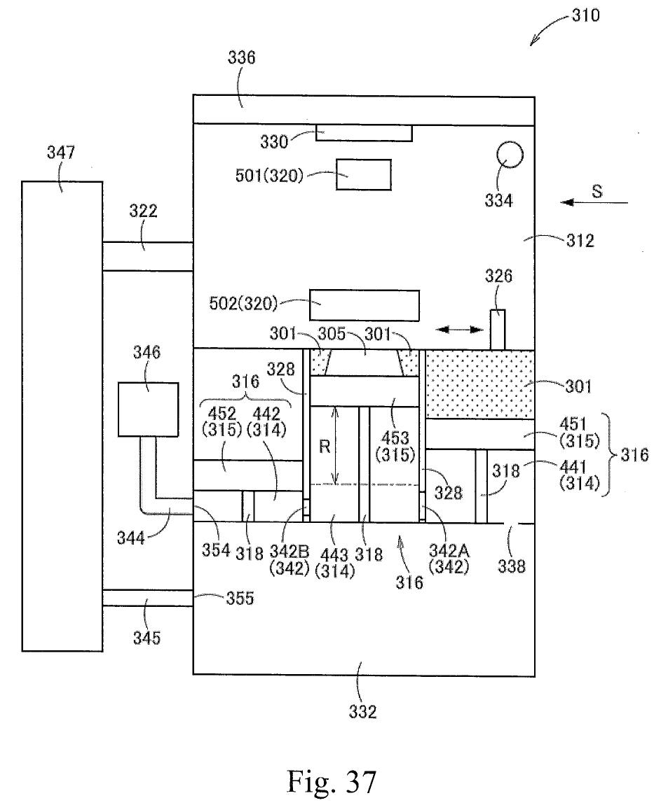

FIG. 37 shows a three-dimensional modeling apparatus 310 according to a fourth mode.

In the three-dimensional modeling apparatus 310 according to this mode, the same or similar elements as in the three-dimensional modeling apparatus 310 according to the third mode described above (see FIG. 36) will be denoted by the same reference numerals and detailed descriptions thereof will be omitted.

In this mode, the first communication hole 342A provided between the dispenser elevation guide chamber 441 and the building elevation guide chamber 443 and the second communication hole 342B provided between the collection elevation guide chamber 442 and the building elevation guide chamber 443 may have different opening cross-sectional areas (channel areas). The cross-sectional area of the first communication hole 342A that communicates between the elevation guide chambers 314 (the dispenser elevation guide chamber 441 and the building elevation guide chamber 443 in this example) having no inert gas supply opening 354 may be larger than the cross-sectional area of the second communication hole 342B that communicates between the elevation guide chamber 314 (the collection elevation guide chamber 442 in this example) having the inert gas supply opening 354 and the elevation guide chamber 314 (the building elevation guide chamber 443 in this example) having no inert gas supply opening 354.

In other respects, the three-dimensional modeling apparatus 310 according to this mode may be the same as that of the third mode described above.

Since the dispenser elevation guide chamber 441 is remote from the inert gas supply opening 354, the inert gas may be supplied to the dispenser elevation guide chamber 441 at a relatively low pressure. However, in this mode, the inert gas can be supplied to the dispenser elevation guide chamber 441 via the first communication hole 342A having a large cross-sectional area. Therefore, it may be possible to generate a gas flow through the collection elevation guide chamber 442, the building elevation guide chamber 443, the dispenser elevation guide chamber 441, and the drive chamber 332 and discharge the oxygen gas accumulating in the elevation guide chambers 314 and the drive chamber 332.

It may also be possible to provide a plurality of first communication holes 342A and/or a plurality of second communication holes 342B. That is, a plurality of first communication holes 342A may be provided in the partition wall 328 between the dispenser elevation guide chamber 441 and the building elevation guide chamber 443, and a plurality of second communication holes 342B may be provided in the partition wall 328 between the collection elevation guide chamber 442 and the building elevation guide chamber 443. In this arrangement, it may be possible that the opening cross-sectional area of one of the first communication holes 342A is not larger than the opening cross-sectional area of one of the second communication holes 342B. The same effect as in this mode can be expected when the sum of the opening cross-sectional areas of the one or more first communication holes 342A provided between the dispenser elevation guide chamber 441 and the building elevation guide chamber 443 is larger than the sum of the opening cross-sectional areas of the one or more second communication holes 342B provided between the collection elevation guide chamber 442 and the building elevation guide chamber 443. Accordingly, even when the opening cross-sectional area of one of the first communication holes 342A is not larger than the opening cross-sectional area of one of the second communication holes 342B, the number of the first communication holes 342A may be larger than the number of the second communication holes 342B such that the sum of the opening cross-sectional areas of the first communication holes 342A is larger than the sum of the opening cross-sectional areas of the second communication holes 342B.

Further, the relationship between the opening cross-sectional areas of the first communication pipe 324A and the second communication pipe 324B may not be limited to the above examples. For example, the sum of the opening cross-sectional areas of the one or more first communication pipes 324A may be smaller than the sum of the opening cross-sectional areas of the one or more second communication pipes 324B.

### <Fifth Mode>

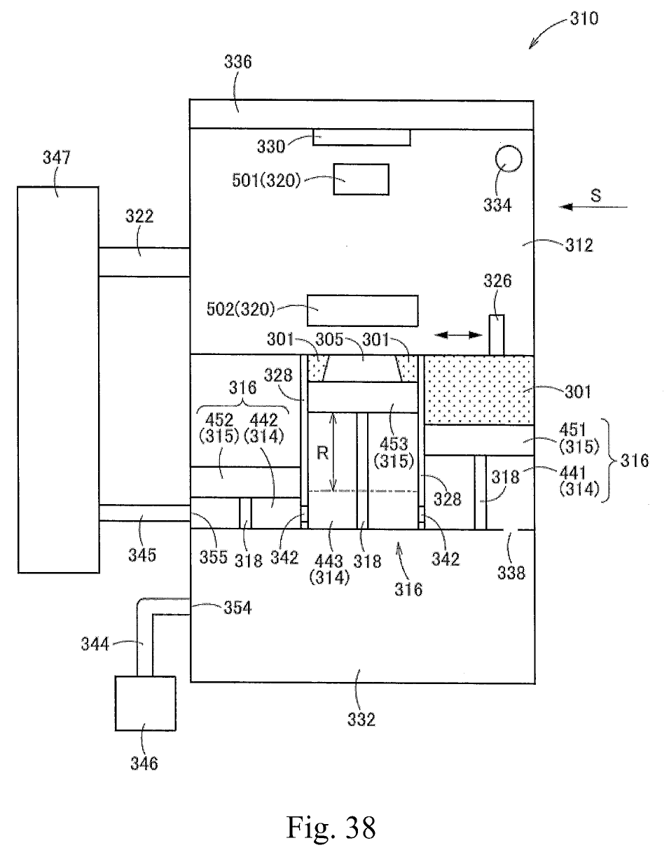

FIG. 38 shows a three-dimensional modeling apparatus 310 according to a fifth mode.

In the three-dimensional modeling apparatus 310 according to this mode, the same or similar elements as in the three-dimensional modeling apparatus 310 according to the second mode described above (see FIG. 36) will be denoted by the same reference numerals and detailed descriptions thereof will be omitted.

In this mode, the inert gas supply opening 354 may be opened to the drive chamber 332, the gas discharge opening 355 may be opened to the elevation guide chamber 314 (the collection elevation guide chamber 442 in this example), and the drive chamber 332 and the elevation guide chamber 314 (the collection elevation guide chamber 442 in this example) may communicate with each other via the dispenser elevation guide chamber 441, the building elevation guide chamber 443, and the communication hole 342.

In other respects, the three-dimensional modeling apparatus 310 according to this mode may be the same as that of the third mode described above.

In this mode, the inert gas supplied via the inert gas supply opening 354 may move through the drive chamber 332, the dispenser elevation guide chamber 441, the building elevation guide chamber 443, and the collection elevation guide chamber 442 and flow out through the gas discharge unit 355. Therefore, in this mode, it may also be possible to fill the elevation guide chambers 314 and the drive chamber 332 with the inert gas and efficiently discharge the oxygen gas accumulating in the elevation guide chambers 314 and the drive chamber 332.

### <Sixth Mode>

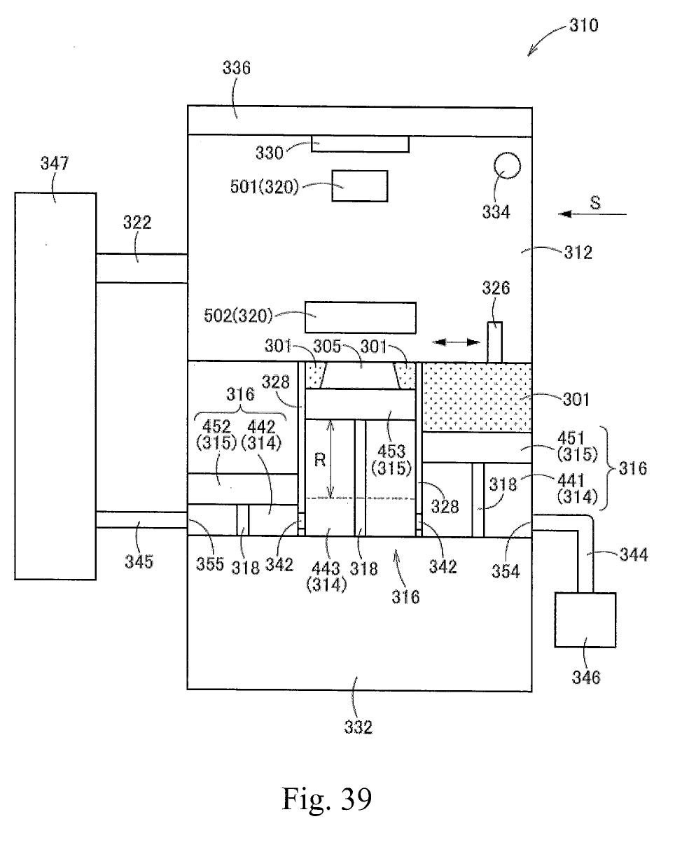

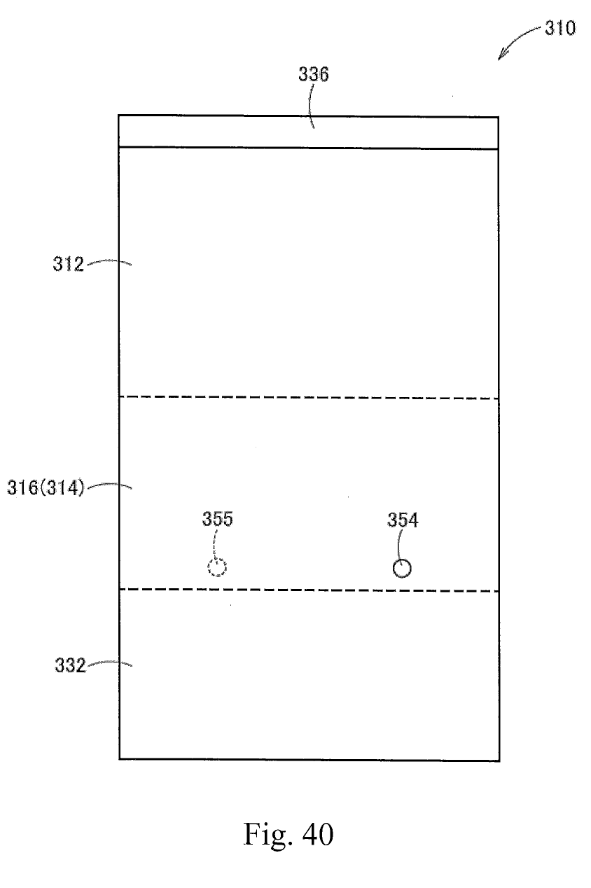

FIG. 39 shows a three-dimensional modeling apparatus 310 according to a sixth mode. FIG. 40 shows the three-dimensional modeling apparatus 310 of FIG. 39 as viewed from a side thereof (see the arrow S in FIG. 39). In FIG. 40, the inert gas supply opening 354 is shown, but the inert gas supply pipe 344 and the inert gas supply unit 346 connected to the inert gas supply opening 354 are omitted, so as to facilitate comprehension.

In the three-dimensional modeling apparatus 310 according to this mode, the same or similar elements as in the three-dimensional modeling apparatus 310 according to the second mode described above (see FIG. 35) will be denoted by the same reference numerals and detailed descriptions thereof will be omitted.

In this mode, the wall portion of the dispenser elevation guide chamber 441 in which the inert gas supply opening 354 is formed and the wall portion of the collection elevation guide chamber 442 in which the gas discharge opening 355 is formed may be opposed to each other. That is, the inert gas supply opening 354 and the gas discharge opening 355 may be respectively provided in the wall portions opposed to each other.

In this mode, the inert gas supply opening 354 and the gas discharge opening 355 may be offset from each other. More specifically, the inert gas supply opening 354 may not be in the line extending from the gas discharge opening 355 in the direction of opening of the gas discharge opening 355, but may be offset from this line in the elevation guide chamber 314 (the dispenser elevation guide chamber 441). Accordingly, the projection of the inert gas supply opening 354 with respect to the direction of the inert gas supply opening 354 (the direction of opening of the inert gas supply opening 354 (the left right direction in FIG. 39 and the direction of depth in FIG. 40)) may be offset and separated from the projection of the gas discharge opening 355 with respect to the same direction. The direction in which the inert gas supply opening 354 and the gas discharge opening 355 are offset from each other is not particularly limited. In the example shown in FIGS. 39 and 40, the inert gas supply opening 354 and the gas discharge opening 355 may be offset from each other in a horizontal direction that is perpendicular to the vertical direction.

In other respects, the three-dimensional modeling apparatus 310 according to this mode may be the same as that of the third mode described above.

In this mode, the gas discharge opening 355 may not be in the line extending from the inert gas supply opening 354 in the direction of the blow of the inert gas from the inert gas supply opening 354. Accordingly, the inert gas supplied via the inert gas supply opening 354 can be effectively prevented from being discharged via the gas discharge opening 355 before the inert gas spreads throughout the plurality of elevation guide chambers 314. Therefore, it may be possible to efficiently fill the plurality of elevation guide chambers 314 with the inert gas and efficiently discharge the oxygen gas accumulating in the plurality of elevation guide chambers 314.

### <Seventh Mode>

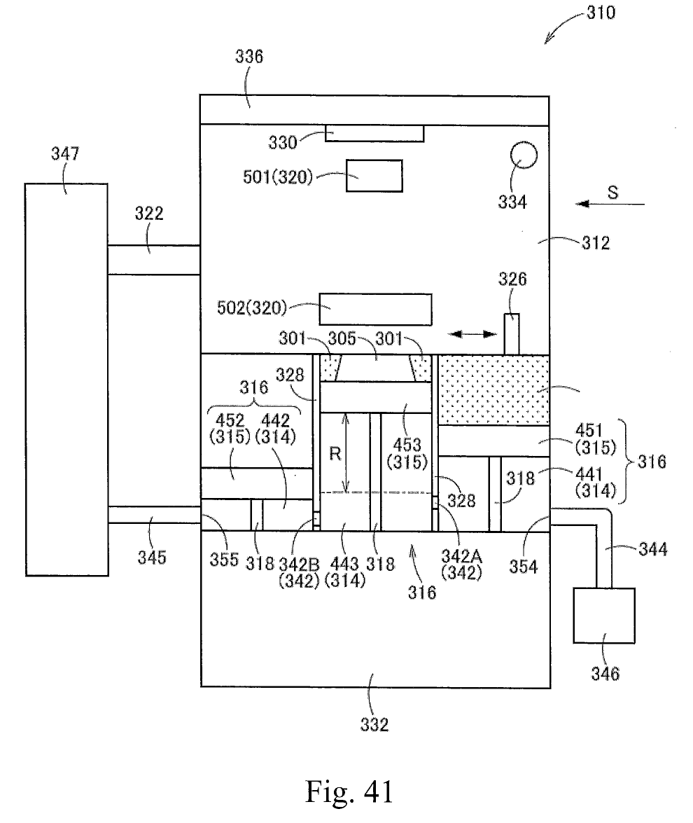

FIG. 41 shows a three-dimensional modeling apparatus 310 according to a seventh mode.

In the three-dimensional modeling apparatus 310 according to this mode, the same or similar elements as in the three-dimensional modeling apparatus 310 according to the sixth mode described above (see FIGS. 39 and 40) will be denoted by the same reference numerals and detailed descriptions thereof will be omitted.

In this mode, the first communication hole 342A provided between the dispenser elevation guide chamber 441 and the building elevation guide chamber 443 and the second communication hole 342B provided between the collection elevation guide chamber 442 and the building elevation guide chamber 443 may be offset from each other. More specifically, the line extending from the first communication hole 342A in the direction in which the first communication hole 342A faces (the direction of opening) may be misaligned with the line extending from the second communication hole 342B in the direction in which the second communication hole 342B faces (the direction of opening). Therefore, the projection of the first communication hole 342A with respect to the direction of opening of the first communication hole 342A (the left-right direction in FIG. 41) may be separated from the projection of the second communication hole 342B with respect to the same direction. The direction in which the first communication hole 342A and the second communication hole 342B are offset from each other is not particularly limited. In the example shown in FIG. 41, the first communication hole 342A and the second communication hole 342B may be offset from each other in the vertical direction.

In this mode, the inert gas supply opening 354 and the gas discharge opening 355 may be respectively provided in the wall portions opposed to each other, and the gas discharge opening 355 may be provided in the line extending from the inert gas supply opening 354 in the direction in which the inert gas supply opening 354 faces (the direction of opening). In this mode, the plurality of communication holes (the first communication hole 342A and the second communication hole 342B) may include a communication hole (the first communication hole 342A in the example shown in FIG. 41) that is separated and offset from the line connecting the inert gas supply opening 354 with the gas discharge opening 355.

In other respects, the three-dimensional modeling apparatus 310 according to this mode may be the same as that of the sixth mode described above.

In this mode, the first communication hole 342A that may communicate between the dispenser elevation guide chamber 441 and the building elevation guide chamber 443 may be separated from the line extending from the inert gas supply opening 354 in the direction of the blow of the inert gas from the inert gas supply opening 354 (the first communication hole 342A may be offset from the inert gas supply opening 354). Accordingly, the inert gas supplied via the inert gas supply opening 354 can be effectively prevented from being delivered to the process chamber 312 via the elevation chamber opening 324b of the communication pipe 324 before the inert gas spreads throughout the plurality of elevation guide chambers 314.

### <Variations>

The present invention is not limited to the modes and variations described above and is susceptible of various modification. Also, any parts or the entirety of the above modes and variations may be combined with each other.

For example, in the above modes, three elevation units 316 (the dispenser unit, the building unit, and the collection unit) may be provided. Alternatively, the three-dimensional modeling apparatus 310 may include only one or two elevation units 316 or include four or more elevation units 316. Accordingly, in the three-dimensional modeling apparatus 310, for example, the collection elevation guide chamber 442 may not contain the collection elevation stage 452 of the collection unit.

The positions of the inert gas supply opening 354 and the gas discharge opening 355 may be modified as necessary. For example, the inert gas supply opening 354 and the gas discharge opening 355 may be opened to one or more of the plurality of elevation guide chambers 314 (the dispenser elevation guide chamber 441, the building elevation guide chamber 443, and the collection elevation guide chamber 442).

In the above modes, the powder material 301 may be solidified (sintered) with a laser beam, but the means for solidifying the powder material 301 is not particularly limited. For example, the emission unit 330 may emit an electron beam, and the powder material 301 may solidify when irradiated with the electron beam emitted from the emission unit 330.

The present invention is not limited to the above embodiments and variations but may include various aspects modified variously as could be conceived by those skilled in the art, and the effects produced by the present invention are not limited to those described above. Accordingly, addition, modification, and partial deletion of the elements described in the specification or recited in the claims can be made within the technical idea and the purport of the present invention.

What is claimed is:

1. A three-dimensional modeling apparatus for modeling a three-dimensional object by lamination modeling in an air-tight process chamber, the three-dimensional modeling apparatus comprising:
an elevation guide chamber provided adjacent to the process chamber;
an elevation stage provided so as to be capable of being raised and lowered in the elevation guide chamber; and
at least one communication pipe communicating between a space below the elevation stage in the elevation guide chamber and the process chamber.

2. The three-dimensional modeling apparatus of claim 1, wherein the at least one communication pipe communicates between a space below a movement range of the elevation stage in the elevation guide chamber and the process chamber.

3. The three-dimensional modeling apparatus of claim 1, wherein the elevation stage serves for modeling conducted thereon.

4. The three-dimensional modeling apparatus of claim 1, wherein the at least one communication pipe comprises a plurality of communication pipes.

5. The three-dimensional modeling apparatus of claim 1, wherein the at least one communication pipe includes a curved channel.

6. The three-dimensional modeling apparatus of claim 1, wherein the at least one communication pipe communicates with the process chamber at a position closer to an oxygen sensor than to a gas supply unit, the oxygen sensor being configured to sense an oxygen density in the process chamber, the gas supply unit being configured to supply an inert gas to the process chamber.

7. The three-dimensional modeling apparatus of claim 1, further comprising:
a drive chamber containing at least a part of an elevation drive unit configured to raise and lower the elevation stage,
wherein the drive chamber communicates with the elevation guide chamber via a communication aperture, and
the at least one communication pipe communicates between the drive chamber and the process chamber.

8. The three-dimensional modeling apparatus of claim 2, further comprising:
a drive chamber containing at least a part of an elevation drive unit configured to raise and lower the elevation stage,
wherein the at least one communication pipe further communicates between the process chamber and the drive chamber.

9. The three-dimensional modeling apparatus of claim 2, further comprising:
a drive chamber containing an elevation drive unit configured to raise and lower the elevation stage, and
at least one communication aperture in a wall between the elevation guide chamber and the drive chamber, the at least one communication aperture communicating between the elevation guide chamber and the drive chamber.

10. The three-dimensional modeling apparatus of claim 1, wherein
the three-dimensional modeling apparatus comprises a plurality of elevation units each including the elevation guide chamber and the elevation stage,
the at least one communication pipe comprises a plurality of communication pipes,
the plurality of communication pipes include a first communication pipe and a second communication pipe,
the first communication pipe communicates with the elevation guide chamber at a position above the position where the second communication pipe communicates with the elevation guide chamber,
the plurality of communication pipes communicate between at least one of the elevation guide chambers of the plurality of elevation units and the process chamber, and
the plurality of elevation guide chambers are arranged adjacent to each other, and any two elevation guide chambers arranged adjacent to each other communicate with each other via a communication hole.

11. The three-dimensional modeling apparatus of claim 1, wherein
the at least one communication pipe includes a plurality of branch pipes, the plurality of branch pipes being respectively connected to a plurality of connection openings provided in a wall portion of the elevation guide chamber at a plurality of different positions with respect to a vertical direction,
each of the plurality of branch pipes is provided with a valve configured to open and close a channel,
the three-dimensional modeling apparatus further comprises:
an opening/closing control unit configured to open and close the valves in accordance with an elevation level of the elevation stage, and
the opening/closing control unit controls the valves so as to close the channels of the branch pipes connected to the connection openings provided in a space above the elevation stage in the elevation guide chamber.

12. The three-dimensional modeling apparatus of claim 1, further comprising:
a first gas supply unit configured to supply an inert gas to the process chamber, and
a second gas supply unit configured to supply the inert gas to the elevation guide chamber.

13. A three-dimensional modeling apparatus for modeling a three-dimensional object by lamination modeling in an air-tight process chamber, the three-dimensional modeling apparatus comprising:
an elevation guide chamber provided adjacent to the process chamber;
an elevation stage provided so as to be capable of being raised and lowered in the elevation guide chamber;
an inert gas supply opening for supplying an inert gas to a space below the elevation stage in the elevation guide chamber, and
a gas discharge opening for discharging gases in the space below the elevation stage in the elevation guide chamber.

14. The three-dimensional modeling apparatus of claim 13, wherein the inert gas supply opening and the gas discharge opening are opened to a space below a movement range of the elevation stage in the elevation guide chamber.

15. The three-dimensional modeling apparatus of claim 13, wherein the elevation stage serves for modeling conducted thereon.

16. The three-dimensional modeling apparatus of claim 13, wherein the inert gas supply opening and the gas discharge opening are provided at different positions with respect to a vertical direction.

17. The three-dimensional modeling apparatus of claim 13, wherein
the three-dimensional modeling apparatus comprises a plurality of elevation units each including the elevation guide chamber and the elevation stage,
the inert gas supply opening and the gas discharge opening are opened to at least one of the elevation guide chambers of the plurality of elevation units, and
the plurality of elevation guide chambers are arranged adjacent to each other, and any two elevation guide chambers arranged adjacent to each other communicate with each other via a communication hole.

18. The three-dimensional modeling apparatus of claim 13, further comprising:
a drive chamber containing an elevation drive unit configured to raise and lower the elevation stage,
wherein the drive chamber communicates with the elevation guide chamber via a communication aperture,
the inert gas supply opening is opened to the elevation guide chamber, and
the gas discharge opening is opened to the drive chamber.

19. The three-dimensional modeling apparatus of claim 13, further comprising:
a drive chamber containing an elevation drive unit configured to raise and lower the elevation stage,
wherein the inert gas supply opening is opened to the drive chamber,
the gas discharge opening is opened to the elevation guide chamber, and
the drive chamber and the elevation guide chamber communicate with each other.

20. The three-dimensional modeling apparatus of claim 13, wherein the gas discharge opening is connected to a gas collection unit configured to collect the gases, the gas collection unit serving as a recycling unit configured to recycle the inert gas.
